(19) United States
(12) Patent Application Publication
(10) Pub. No.: US 2025/0371598 A1
(43) Pub. Date: Dec. 4, 2025

(54) GENERATING INTENT DATA DRIVEN PREDICTION FOR A TARGET COMPANY ASSOCIATED WITH MULTIPLE TOPICS OF INTEREST BASED ON CUSTOM INPUTS INCLUDING HISTORICAL CONTEXT ANALYSIS RELATED TO BUYING FUNNEL STAGES

(71) Applicant: Bombora, Inc., New York, NY (US)

(72) Inventors: Erik G. Matlick, Miami Beach, FL (US); Elena Drozd, New York, NY (US); Cassie M. Williams, New York, NY (US); Derek Patrick McIntyre, New York, NY (US); James Christian Freeman, New York, NY (US)

(73) Assignee: Bombora, Inc., New York, NY (US)

(21) Appl. No.: 19/221,369

(22) Filed: May 28, 2025

Related U.S. Application Data
(60) Provisional application No. 63/653,695, filed on May 30, 2024.

(51) Int. Cl. G06Q 30/0601

(52) U.S. Cl. CPC G06Q 30/0627; G06Q 30/0629

(57) ABSTRACT

Disclosed embodiments include a content consumption monitor (CCM) that receives a name or domain of a customer and historical context data. A set of topics are identified that are most relevant to the customer based on the name/domain. The set of topics is ranked in order of highest relevancy. The CCM determines which topics in the ranked set most closely match with a set of target topics for which a target company has shown interest, the target topics having a corresponding topic interest score indicating interest level. The matching topics are associated with the corresponding topic interest scores. The CCM identifies at which buying funnel stage the matching topics are in based on the topic interest scores, and the historical context data. The CCM generates an intent signal comprising the matching topics and corresponding topic interest scores, and associated buying funnel stage of the matching topics.

### PRIORITY

This application is a non-provisional of U.S. Provisional Application No. 63/653,695 filed on May 30, 2024, which is incorporated by reference herein.

### TECHNICAL FIELD

Embodiments described herein generally relate to machine learning (ML) and artificial intelligence (AI), and in particular, ML/AI techniques for generating intent data driven prediction for a target company associated with multiple topics of interest based on custom inputs including historical context analysis related to buying funnel stages.

### BACKGROUND

Companies struggle to use any new data source, especially any intent data. Intent data refers to information that captures the online behaviors and activities of businesses and organizations that may indicate their potential interest in or intent to purchase specific products or services. Intent data is typically used by B2B (business-to-business) companies to identify and prioritize sales leads and prospects.

Intent data of a target company is typically gathered from various online sources, such as web browsing behavior, online research and content consumption, social media activity, online event attendance, and job postings and hiring activity. Web browsing behavior can be gathered by tracking the websites and web pages that potential target companies visit, the content they consume, and the searches they perform. For example, if a company visits a software vendor's website and downloads product information or pricing details, it could indicate purchase intent. Online research and content consumption data are collected on the types of content (e.g., whitepapers, webinars, reports) that companies access or download, which can provide insights into their specific interests or pain points. Social media activity is collected based on a company's social media interactions, posts, and discussions related to products, services, or industry topics, which can signal potential intent or interest. Online event attendance and participation in virtual events, webinars, or product demos is also collected and is another strong indicator of purchase intent by the target company. Job postings and hiring activity by the target company for specific roles or expanding teams in certain areas may indicate plans for growth or new initiatives, which could translate into purchase intent for related products or services.

Specialized data providers aggregate and analyze intent data using various techniques to identify and score intent signals. This data is then packaged and provided or sold to customers of the data providers. The customers then use the intent signal scores to prioritize their sales and marketing efforts by focusing on prospect companies that exhibit the highest levels of intent or interest.

Aggregating and consolidating data from these disparate sources is complex and time-consuming. Prior intent data solutions generate intent data by determining how a target company and its services/products relate to a particular topic in any category of the business. Although this provides a useful indicator for the target company's sales and marketing personnel, the solution is fine-grained and particular—the intent data score typically covers only a single topic of interest for a given target company. The output of prior data provider systems may include large sets of intent data scores for groups of separate topics for a single target company and multiple sets of intent data scores corresponding to multiple groups of target companies.

Many companies, even those with a large data science organization, abandon the effort to onboard all this intent data and fail to realize any value from it. Too much data can be overwhelming. Sorting through a vast amount of granular data without effective tools and processes can lead to analysis paralysis and missed opportunities.

Accordingly, there is a need for an improved intent data system that enables customers to leverage the intent data, improve lead generation and targeting, increase sales efficiency, and drive better revenue growth in their B2B operations.

### BRIEF DESCRIPTION OF THE DRAWINGS

FIG. 1 depicts an example content consumption monitor (CCM).

FIG. 2 is a flow diagram illustrating a process performed by the intent signal builder service of the CCM according to one embodiment.

FIGS. 3A and 3B are diagrams illustrating the intent signal data builder service in further detail in accordance with the disclosed embodiments.

FIG. 4 is a diagram illustrating an example of the topic creation dashboard UI 160A.

FIG. 5A is a diagram illustrating an example portion of topic data samples.

FIG. 5B is a diagram illustrating an example portion of a topic taxonomy graph stored in the topic taxonomy.

FIG. 6A is a flow diagram showing a process performed by the graph lookup process to find a set of topics associated with company-related terms according to one embodiment.

FIG. 6B is a flow diagram showing a process performed by the graph inference process to find a set of additional topics that are predicted to be relevant concept-level topics and named entity topics according to one embodiment.

FIG. 7 is a diagram illustrating components of, and the processing performed by, the classification service.

FIG. 8A is a diagram illustrating a process of determining buying funnel stages. In a one embodiment, further historical context analysis related to buying funnel stages is used to create the intent signal.

FIG. 8B illustrates a flowchart of a buying stage algorithm 808 shown in FIG. 8A.

FIG. 9 is a diagram illustrating a buying stages graph.

FIG. 10 is a diagram illustrating an example Intent signal.

FIG. 11 depicts an example computing system suitable for practicing various aspects of the various embodiments discussed herein.

FIG. 12 illustrates an example neural network suitable for practicing the various embodiments discussed herein.

### DETAILED DESCRIPTION

Methods and systems are disclosed for generating intent data driven prediction for a target company associated with multiple topics of interest based on custom inputs including historical context analysis related to buying funnel stages. Companies may research topics on the Internet as a prelude to purchasing items or services related to the topics. Methods and systems disclosed herein provide a content consumption monitor (CCM) that generates consumption scores called an intent signal. In embodiments, the intent signal is a high-level, more actionable intent indicator than previous solutions in that it provides customers with insights about a target company's level of interest across many different topics, rather than a single topic. The CCM may go beyond just identifying target companies interested in specific topics and also identify surge data indicating when the target companies are most receptive to direct contacts regarding different topics as well as identify what contact method the target companies are most receptive to. Service providers and/or publishers who are customers of the CCM may use the intent signal and surge data to increase interest in published information. In one example, the service providers and/or publishers may include advertisers who use the surge data to increase advertising conversion rates.

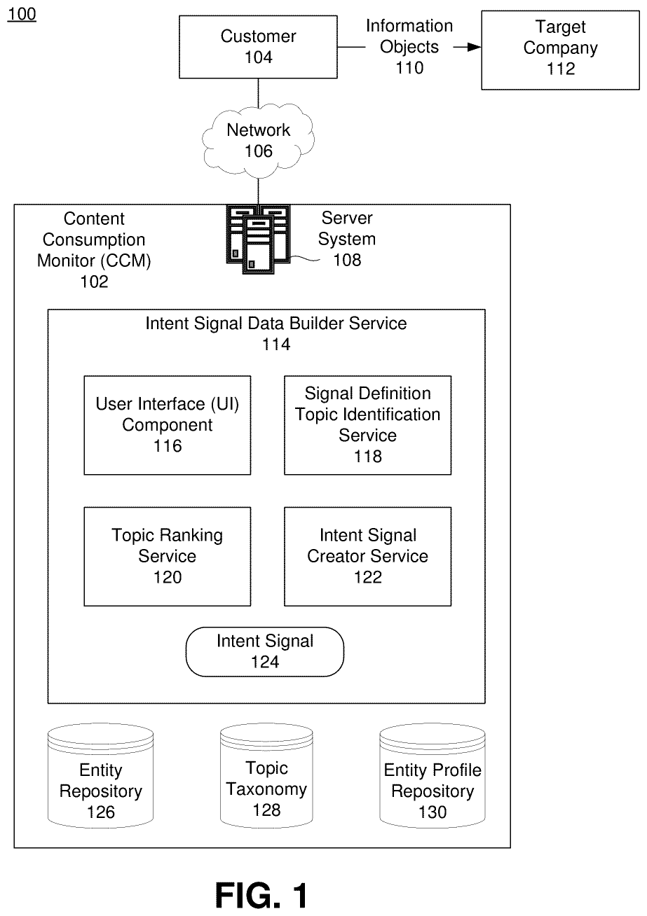

FIG. 1 is a diagram illustrating a content consumption system. The content consumption system 100 comprises a content consumption monitor (CCM) 102 that electronically communicates with a customer service provider (hereinafter customer 104) over a network 106 (e.g., the Internet) through a server system 108. Customer 104 is any server or computer operated by a company enterprise, and/or individual that wants to send information object(s) 110 or content to an interested group of one or more target companies 112.

In some implementations, the information objects 110 may include webpages provided on (or served) by one or more web servers and/or application servers operated by different service providers, businesses, and/or individuals. For example, information objects 110 may come from different websites operated by online retailers and wholesalers, online newspapers, universities, blogs, municipalities, social media sites, or any other entity that supplies content. Additionally or alternatively, information objects 110 may also include information not accessed directly from websites. For example, users may access registration information at seminars, retail stores, and other events. Information objects 110 may also include content provided by service provider 104. Additionally, information objects 110 may be associated with one or more topics. The topic of an information object 110 may refer to the subject, meaning, and/or theme of that information object 110.

Computers and/or servers associated with the CCM 102, customer 104, and target company 112 may communicate over the Internet or any other wired or wireless network including local area networks (LANs), wide area networks (WANs), wireless networks, cellular networks, Wi-Fi networks, Bluetooth® networks, cable networks, or the like, or any combination thereof.

The CCM 102 comprises an intent signal data builder service 114. In one embodiment, the intent signal data builder service 114 may comprise several components including a user interface (UI) component 116, a signal definition topic identification service 118, a topic ranking service 120, and an intent signal creator service 122, at least one entity repository 126, at least one concept taxonomy 128, and at least on entity profile repository 130.

According to the disclosed embodiments, the intent signal data builder service 114 generates a consumption score called an intent signal for the target company 112 to which the customer 104 is interested in providing information objects 110.

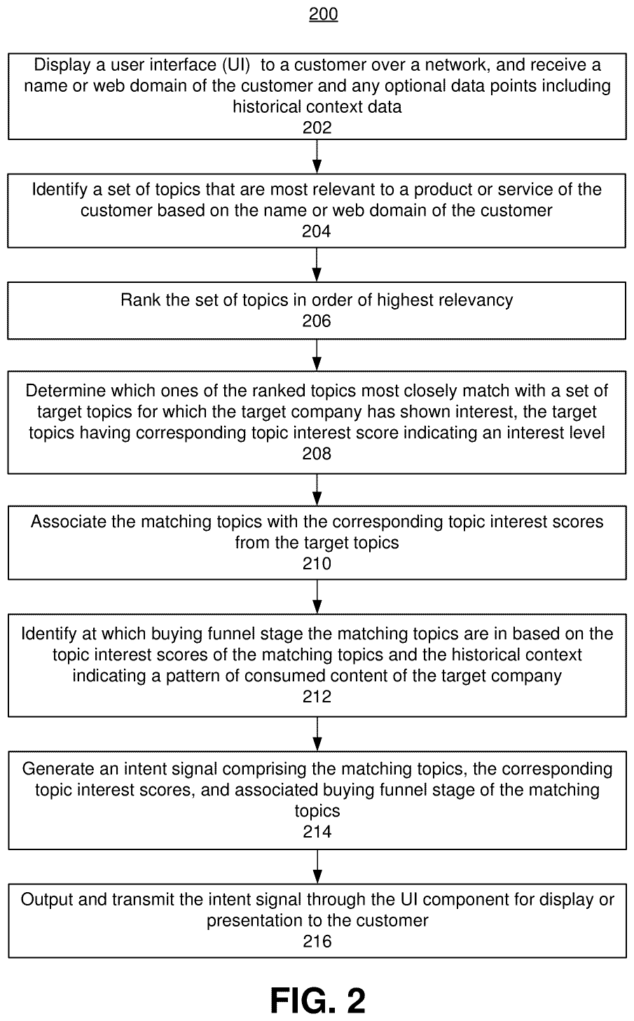

FIG. 2 is a flow diagram illustrating a process performed by the intent signal builder service of the CCM 102 according to one embodiment. The process 200 may include displaying the UI component 116 over the network to the customer 104, receiving minimal required information such as a name or web domain of the customer 104, and receiving any optional data points including historical context data, the customer's goals, product descriptions, PDFs, URLs (block 202). The historical context is preferably a description of closed lost deals or closed won deals (e.g., CRM (customer relationship management) data) of the customer 104, the target company, or between the customer 104 and the target company 112. In one embodiment, the historical context may be provided as customer relationship management (CRM) data.

Based on this minimal information, the main tasks performed by the CCM 102 are the following. The signal definition topic identification service 118 first identifies a set of multiple topics, rather than a single topic, that are most relevant to the customer's business (e.g., a product or service) using the company's name or web domain (block 204). In one embodiment, the signal definition topic identification service 118 identifies a larger category of topics by first identifying an initial set of topics based on content extracted from at least the URLs and PDFs of the customer 104, and then sequentially identifying additional topics, inferred topics, or similar topics determined to be of relevance to the customer 104 and its products/services.

The topic ranking service 120 ranks the set of topics in order of highest relevancy (block 206). In one embodiment, the set of ranked topics may be pruned by discarding the topics ranked below a predetermined threshold. In addition, the set of ranked topics may be displayed through the UI component 116 to the customer 104 for the customer 104 to accept all or a subset of the topics, add topics, or delete topics from the set to further refine the relevancy of the topics to the customer's goals.

The intent signal creator service 122 determines which ones of the ranked topics most closely match a set of target topics for which the target company 112 has shown interest, the target topics having corresponding topic interest scores indicating an interest level (block 208). The intent signal creator service 122 also associates the matching topics with the corresponding topic interest scores from the target topics (block 210).

In one embodiment, an entity profile repository 130 stores topic interest data that includes topic interest scores identifying a set of target topics for which the target company is interested, and the topic interest score for each target topic indicates the interest level. In one embodiment, the topic interest scores may be represented by values between 0 and 100, indicating the target company's interest in a specific target topic.

The intent signal creator service 122 accesses the entity profile repository 120 and determines which topics from the signal definition for the customer 104 most closely match the set of target topics for which the target company has shown interest. The matching topics are then associated with the corresponding topic interest score, indicating the interest level.

For example, assume the customer accepts twenty-five topics from the signal definition. Assume further that the target interest scores for the target company 112 from the entity profile repository 130 indicate that the target company 112 is interested in fifteen of those twenty-five topics. Those fifteen topics are associated with the target company 112, creating target account topic pairs, and each will include the topic interest score indicating the interest level. One topic pair might be associated with a topic interest score of 60, one topic might be associated with a topic interest score of 20, and another with 95, for instance. In one embodiment, specific topic interest scores may be associated with topics for each of the entities stored in the entity profile repository 130 or in another database.

The intent signal creator service 122 identifies at which buying funnel stages the matching topics are in based on the topic interest scores of the matching topics, and the historical context data indicating a pattern of consumed content of the target company (block 212). In one embodiment, identification of the buying funnel stage is based at least in part on the historical content data indicating an acceleration of online research frequency and depth of engagement in that topic by the target company during the different buying funnel stages.

The intent signal creator service 122 generates an intent signal 124 comprising the matching topics, corresponding topic interest scores, and associated buying funnel stage of the matching topics (block 214). In one embodiment, the intent signal 124 may comprise a single score generated by aggregating the topic interest scores.

The CCM 102 outputs and transmits the intent signal 124 through the UI component 116 for display or presentation to the customer 104 (block 214). In embodiments, the intent signal 124 is a prediction of whether the target company is a candidate for outreach by customer 104 and is likely to interact with marketing or sales methods of customer 104 within the different sales funnel stages of the topics.

A buying funnel, also known as a sales funnel or purchase funnel, is a marketing model that illustrates the theoretical journey a potential customer goes through, from initial awareness of a product or service to the final purchase decision. It is represented as a funnel shape, with the wide opening at the top representing a large pool of potential targets, and the narrow end at the bottom representing the smaller number of targets who actually make a purchase.

The buying funnel is typically divided into several stages, such as awareness, interest, consideration, intent, evaluation, and purchase. The awareness stage is at the top stage of the funnel, where potential customers become aware of the product or service through various marketing efforts, such as advertising, social media, or word-of-mouth. At the Interest stage, prospects show some level of interest in the product or service and engage further through educational content, demonstrations, or other means to pique their curiosity and desire. At the consideration stage, interested prospects actively evaluate the product or service against competitors, weigh the benefits and drawbacks, and gather more information to make an informed decision. At the intent stage, prospects have a strong inclination to purchase and may request quotes, seek additional details, or take other actions that signal their readiness to buy. At the evaluation stage, prospects thoroughly evaluate the offering, negotiate terms, and address any remaining concerns or objections before making a final decision. The purchase stage is the bottom of the funnel and represents the successful conversion of a prospect into a customer, where they complete the purchase transaction.

According to the disclosed embodiments, the sales-funnel related intent signal 124 indicates where the target company is at a particular phase of its purchase decision process and what optimized actions the customer should take. This is a more coarse-grained indicator that enables sales, support, and marketing personnel to know what target companies they should reach out to, what sorts of tactics they should use to reach out, and what talking points they should use when they do so. One aspect of the disclosed embodiments is enabling the CCM 102 to define a set of topics for the different use cases and determine which topics are relevant to the different buying funnel stages of the target company, and represent that by the intent signal output score.

Adding buying funnel stage information to the intent signal provides value to the customer 104 because the intent signal 124 can now identify to the customer's sales and marketing personnel to which contact methods target companies are most receptive. For example:

Company X appears to be starting the research process for products like the ones the vendor sells, and reaching out via advertising might be a good idea (top-of-funnel marketing)

Company Y, a customer of the vendor, is showing signs that it may be considering changing to a different vendor for the product or service, so support outreach is needed (renewal churn risk)

Company Z is showing signs of imminent purchase intent for products related to the Vendor's product, so sales activity is timely (bottom-of-funnel sales operations)

There are numerous other use cases, but all reside at this business-activity-level layer of granularity, and the signal framework facilitates them.

By analyzing intent signal 124 and determining where the target company is getting stuck or dropping off in the funnel, the customer 104 can identify areas for improvement, optimize their strategies, and ultimately increase their conversion rates and sales.

During the process of generating the intent signal 124, the intent signal data builder service 114 may utilize the entity repository 126, the topic taxonomy 128, and the entity profile repository 130.

The entity repository 126 is a specialized database system designed to store and manage information about named entities. Named entities refer to specific objects, individuals, organizations, locations, or concepts that can be uniquely identified within a given domain or context. Each entity in the database is represented by a record or entry that contains various attributes or properties associated with that entity, such as company-related proper names, product names, legal terms, legal firms, people, and locations. In one embodiment, the entity repository may track company-related proper names for millions of entities. The entity repository 126 may support the ability to define and store relationships between different entities. For example, a product entity could be associated with its manufacturer, or a person entity could be linked to the organizations to which they are employed.

The topic taxonomy 128, also known as a content taxonomy or knowledge taxonomy, is a hierarchical classification system used to organize and categorize information, content, or knowledge within particular domains or subject areas. The topic taxonomy 128 provides a structured way to manage and navigate through large volumes of information by grouping related topics, concepts, or subjects together.

The entity profile repository may be a database or warehouse that stores web usage data from various sources (server logs, client-side tracking, user accounts) for multiple entities. In one embodiment, the web usage data for each entity is aggregated from various users/employees of that entity. Records for each entity may also include intent data or topic interest data. The topic interest data identifies or indicates topics in information objects or third-party content displayed on the web and accessed by the users of the entity. Topic interest data includes or indicates a topic interest score into an interest level exhibited by an entity's users in certain topics based on their web content consumption. For example, topic interest data may comprise a user intent vector that identifies or indicates the topics and identifies levels of user interest in the topics. The topic interest score may be used to form predictions about the target account's potential to take certain actions. The topic interest data may be used to provide a historical baseline for measuring content consumption. In embodiments, the CCM 102 monitors content consumption behavior from a collection of service providers and applies data science and/or ML techniques to identify changes in activity compared to the historical baselines for entities. As examples, research frequency, depth of engagement, and content relevancy all contribute to measuring an org's interest in topic(s). In some embodiments, the CCM 102 may employ an NLP/NLU engine that reads, deciphers, and understands content across the entity repository 126, the entity profile repository 130, and the topic taxonomy 128 that may grow on a periodic basis (e.g., monthly, weekly, etc.).

Components of the intent signal data builder service 114 may utilize various natural language processing (NLP) and/or natural language understanding (NLU) topic analysis models/techniques, as described herein. The topic analysis (also referred to as “topic detection,” “topic modeling,” or “topic extraction”) may utilize one or more topic models. A topic model is a type of statistical model used for discovering topics that occur in a collection of text. A topic model may be used to discover hidden semantic structures in the content or other collections of text. In one example, a topic classification technique is used, where a topic classification model is trained on a set of training data (e.g., information objects 110 and other web data) and then tested on a set of test data to determine how well the topic classification model classifies data into different topics. Once trained, the topic classification model is used to determine/predict which topics from the topic taxonomy 106 are contained in the extracted content. In another example, a topic modeling technique may be used, where a topic modeling model automatically analyzes the extracted content to determine cluster words for a set of documents. Topic modeling is an unsupervised ML technique that does not require training using training data.

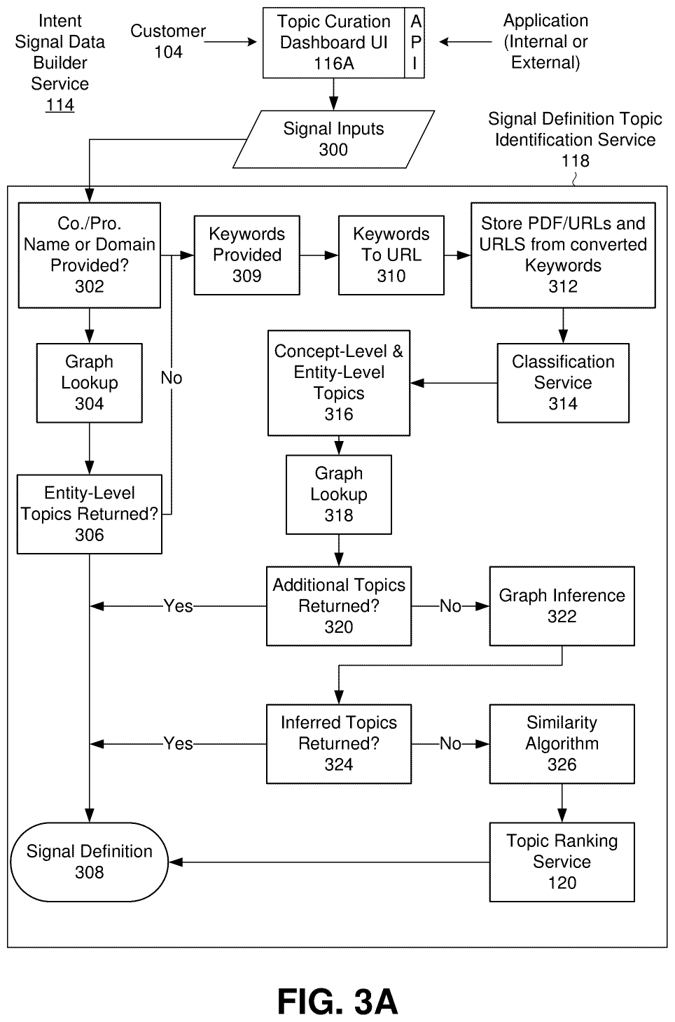

FIGS. 3A and 3B are diagrams illustrating the intent signal data builder service 114 in further detail in accordance with the disclosed embodiments.

The intent signal data builder service 118 is a full-funnel content consumption solution that sequentially identifies a larger concept of many topics and includes a ranking algorithm that outputs an intent signal score that is predictable. Because the signal definition topic identification service iteratively identifies a larger concept of many topics at once, the intent signal score provided back to a customer is something actionable and relevant to the customer's goals, such as sales and marketing.

A UI component referred to as the topic curation dashboard UI 116A displayed by the intent signal creator service 300 is accessed by the customer 104 either over a network via a web browser or through another application, such as a customer relationship management (CRM) app (e.g., Salesforce), via an API gateway. The topic curation dashboard UI 116A begins the intent signal builder process by requesting the customer 104 to enter signal inputs 300.

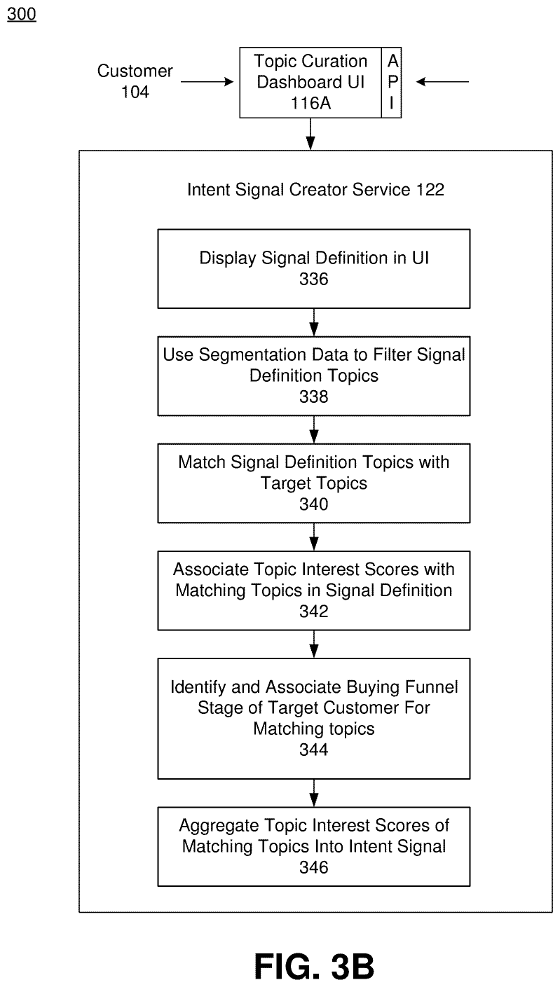

FIG. 4 is a diagram illustrating an example of the topic creation dashboard UI 160A. The topic curation dashboard UI 116A comprises the visual elements and components that enable user interaction, including any combination of screens, buttons, icons, menus, typography, and other visual elements that allow users to read data, input data, navigate, and accomplish tasks such as entering the signal inputs 300.

In one embodiment, the topic curation dashboard UI 116A includes a required user input section 116B and an optional user input section 116C for a user of the customer 104 to enter signal inputs about the customer 104. The required user input section 116B can include prompts, asking for mandatory information for the user to fill out, and input fields with optional labels for entering the requested information, which includes a name or web domain of the customer 104 and/or a product of the customer 104. In one embodiment, the optional user input section 116C can include prompts and input filed with optional labels for input of optional or non-mandatory data points.

In the required user input section 116B, the prompt for the web domain name may refer to a unique name that identifies a website or web service of the customer 104 on the internet. It is a component of a URL (Uniform Resource Locator) that allows users and web browsers to locate and access a specific website or web page. The domain is typically the part of the URL that comes after the protocol (e.g., http://or https://) and before the path or file name. The URL comprises two main parts-a top-Level Domain (TLD) and a Second-Level Domain (SLD) or Base Domain. The TLD is the last part of the domain, such as .com, .org, .net, .gov, or country-specific domains like .uk, .in, or .fr. The TLD indicates the purpose or type of the website (e.g.,.com for commercial, .org for non-profit organizations,.edu for educational institutions). The SLD or Base Domain is the main part of the domain that identifies the specific website or organization. It can be a combination of words, abbreviations, or brand names, such as google, wikipedia, or example. The following is an example of a URL with the domain highlighted “https://www.example.com/products/category1.” In this URL, the domain is “example.com”, where “com” is the Top-Level Domain (TLD), and “example” is the Second-Level Domain (SLD) or Base Domain.

The optional user input section 116C enables the user to input optional data points about the customer 104. The optional data points may comprise any combination of customer marketing or sales goals/use cases/strategy, SEO (search engine) keywords, marketing collateral describing products/services of the customer 104, segmentation data, information about competitors, and customer resource management (CRM) data. The CRM data may include deal open-won-lost data, deal cycle data, and customer and product data. The optional data points may be provided by the customer uploading PDFs, CRM files, and/or typing in the data and URLs where the data can be found.

The system uses the domain and optional data points, such as marketing or sales goals (if given), to generate the intent signal 124 that optimizes the performance of the customer's marketing or sales campaigns at different sales funnel states of the target company 112.

In other aspects, the optional user input section 116C may also enable the user to enter segmentation data. The segmentation data is data used to further filter and weight the intent signal 124. The segmentation data defines any combination of a target account list (TAL) for one or more target companies 112, industries, and markets the customer intends to target. In one embodiment, responsive to the user selecting to enter the segmentation data, the UI displays UI elements to enable the user to enter the segmentation data attributes comprising one or more of the TAL, industry, revenue, employee count, and geographic focus, for example. Alternatively or additionally, the UI may enable the user to select the segmentation data using firmographic data from a database. Firmographic data refers to the demographic and descriptive information about companies or businesses, as opposed to individual consumers. It is used in B2B (business-to-business) marketing and sales to better understand and target potential corporate customers or clients. The segmentation data may be entered at the beginning of the process or after the ranked list of topics is generated and shown to the customer. In many cases, the customer 104 is so busy that they are unable or unwilling to provide the system with optional information about their company, except the name or domain and perhaps segmentation data, which presents the CCM 102 with a sparse data problem.

The following is a high-level overview of the processes described in FIGS. 3A and 3B. Details of the steps in FIGS. 3A and 3B follow this overview. Referring again to FIG. 3A, after the signal inputs 300 are provided, the signal definition topic identification service 118 performs the first part of the process of building the intent signal 124. In embodiments, the signal definition topic identification service 118 is operable to identify a list of relevant topics from the topic taxonomy 128 that are determined to be relevant to the business of the customer 104 and its products/services based on retrieved content about the customer 104/company, which is fundamental to the remaining parts of the process. These topics are saved as signal definition 308. The signal definition topic identification service 118 also identifies a larger category of topics by attempting to sequentially identify additional topics, inferred topics, or similar topics determined to be of relevance to the customer 104 and its products/services. This larger category of topics is also saved to the signal definition 308. This approach provides the advantage of requiring minimal input from the customer while still generating comprehensive and relevant topic sets, saving valuable time and resources for busy customers.

Referring to FIG. 3B, after the signal definition topic identification service 118 has created the signal definition 308 of all relevant topics, the intent signal creator service 122 performs the second part of the process. The intent signal data 122 determines what group of potential target companies 112 would be interested in the relevant topics in the signal definition 308. The next step is determining which of those are relevant to the top, middle, and bottom of the buying funnel stages for those target companies 112 (e.g., sales targets). The customer 104 is attempting to market or sell a product/service that solves a problem of their target companies 112, and simultaneously those target companies 112 are in the process of searching online for, and showing interest, in the product/service at different buying funnel stages, the data for which is stored in the entity profile repository 130.

This approach provides the significant technical advantage of computationally integrating historical context analysis with real-time intent data to create a more accurate predictive model that dynamically maps topic interest patterns to specific buying funnel stages, thereby solving the technical problem of processing and correlating disparate data sources to generate actionable intelligence that traditional intent data processing systems cannot achieve. The system's NLP and machine learning algorithms specifically optimize computational resources by filtering irrelevant data points and focusing processing power on statistically significant correlations between topic interest scores and historical consumption patterns, resulting in measurably improved data processing efficiency and prediction accuracy compared to conventional intent data solutions that lack this technical integration capability.

The intent signal creator service 122 system analyzes the historical context data and determines which set of topics to select based on whether the goal of the customer is a marketing or advertisement, and based on whether the customer 104 already has an open opportunity and trying to close it. In one embodiment, based on the interest level in the selection of relevant topics, the intent signal creator service 122 may predict which target companies 112 are the best candidates for outreach by the customer. The intent signal creator service 122 generates a final selection of relevant topics and maps each to a buying funnel stage of the target companies. The intent signal creator service 122 generates and outputs an intent signal score that is sales-funnel related. The intent signal output is displayed to the customer and indicates which potential target companies would be most likely to interact with what marketing/sales methods of the customer, to provide vendor sales and marketing personnel with more actionable information. Additionally or alternatively, one or more target companies may be provided by the customer.

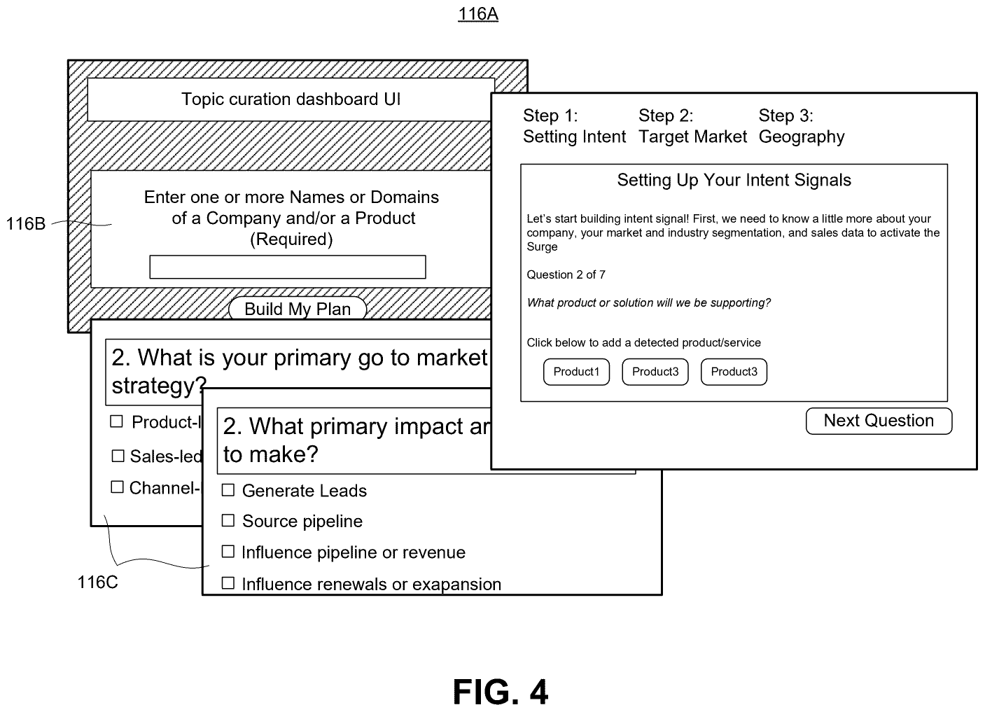

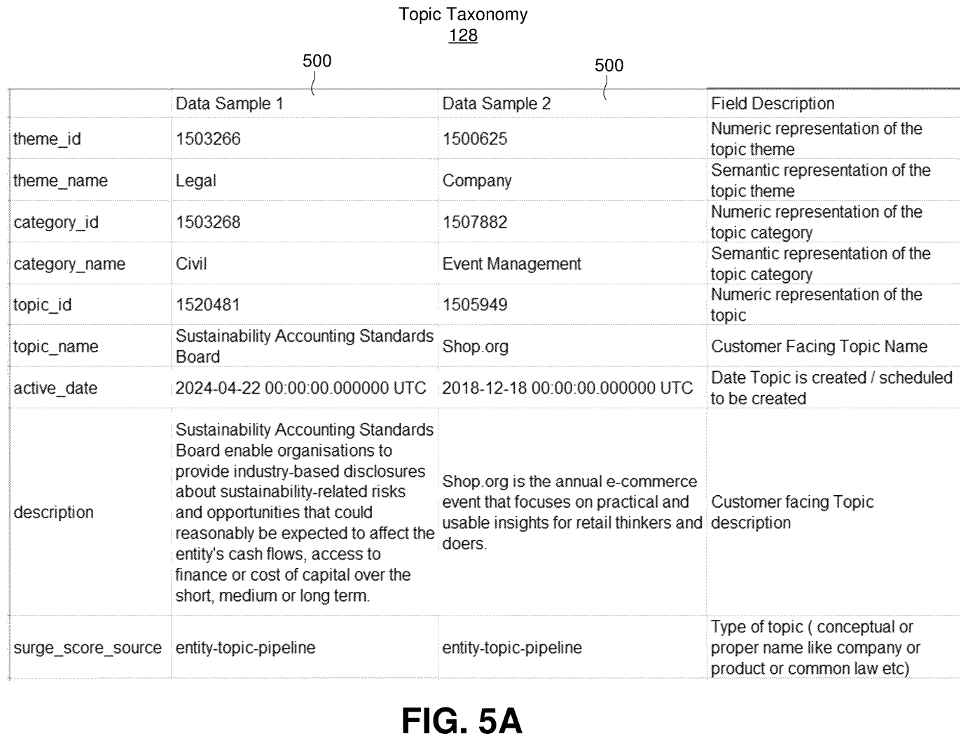

In further detail, referring again to FIG. 3A, the signal definition topic identification service 118 retrieves the signal inputs 300 and first determines whether the signal inputs 300 include any company-related terms, including a company and/or product name or a web domain of the company and/or a product (block 302). If so, the signal definition topic identification service 118 invokes a graph lookup process to determine whether any of the company-related terms are found within a topic taxonomy (block 304). In embodiments, the graph lookup process is performed on information stored in the topic taxonomy 128. In order to describe the graph lookup process, example contents of the topic taxonomy 128 are shown in FIGS. 5A and 5B.

FIG. 5A is a diagram illustrating an example portion of topic data samples/records; and FIG. 5B is a diagram illustrating an example portion of a topic taxonomy graph stored in the topic taxonomy.

Referring to FIG. 5A, the topic taxonomy 128 includes a plurality of data sample records 500 and each comprises a plurality of fields indicating a theme, a category, a topic ID, a topic name, a text description, and a surge_score_source. The data sample records 500 may relate to a concept-level topic that relates to a concept or an entity-level node that relates to some aspect of an entity. Data Sample 1 in column 1 is an example of a concept-level topic having a topic name of “Sustainability Accounting Standards Board Data Sample 2 is an example of an entity-level topic with the topic name of “Shop.org”. Values in the surge_score_source field define whether the topic is concept-level or entity-level.

Referring to FIG. 5B, the topic taxonomy graph 520 comprises a plurality of nodes 522, which include i) entity-level nodes that represent companies/entities (e.g., nodes A, B, C, D), and products/services (e.g., nodes 1, 2, 3, 4), and ii) concept-level nodes that represent content-level topics or entity-level topics (e.g., nodes v, w, x, y, z). The nodes 522 may correspond to the data samples in FIG. 5A. Each node 522 includes descriptions of the corresponding company, product/service, and a link 524 to an associated concept-level topic or entity-level topic. Any two company nodes 522 are considered related if any of their corresponding product nodes share the same concept-level topic or an entity-level topic.

In the topic taxonomy graph 500, Company A and Company B are competitors because both product 1 and product 3 relate to concept-level topic V. Company A and Company C are competitors through product 2 and product 4, which relate to concept-level topic Y.

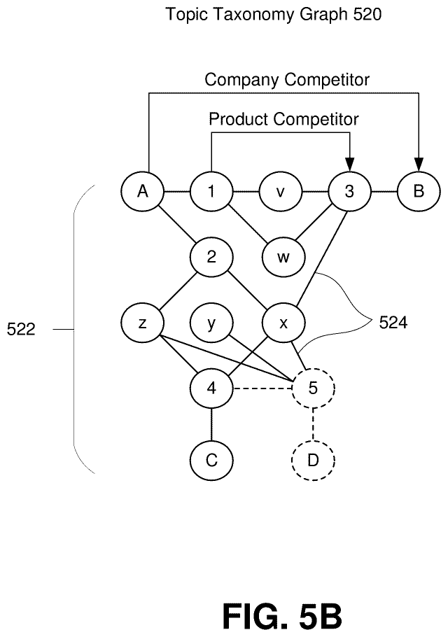

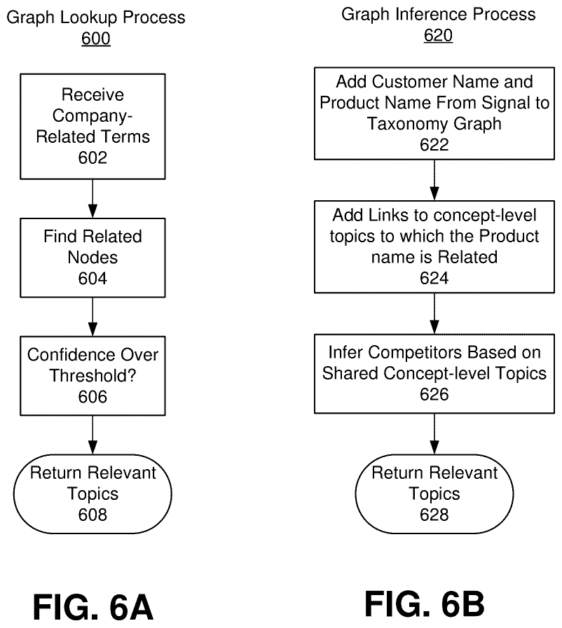

FIG. 6A is a flow diagram showing a process performed by the graph lookup process 600 to find a set of topics associated with company-related terms according to one embodiment. The graph lookup process 600 receives the company-related terms from the signal inputs 300 such as a web domain, and/or a name of a company and/or a product and 0 or more topics (block 602).

For each company-related term, the graph lookup process 600 searches the topic taxonomy 128 to find related nodes having a matching name (block 604). For any nodes to which the matching node is linked, the graph lookup creates and outputs a list of any topics associated with the linked nodes, including directly associated concept-level topics and named entity topics, and the named entity topics of any identified competitor. Named entity topics include both company-named and product-named entity-level topics. A confidence score may be computed for each related topic, indicating a degree of relevance to the company-related term. If the confidence score meets or exceeds a confidence threshold (block 606), the topic is returned in a set of relevant topics (block 608).

As an example and referring to the example shown in FIG. 5B, assume the company-related term is “Product 1”. The graph lookup process 600 would return concept topics “V” and “W”, which are related/associated to Product 1, as well as the named entity topics representing Product 1, Product 3, Company A, and Company B.

Referring again to FIG. 3A, responsive to the signal definition topic identification service 118 determining that any entity-level topics are returned by the graph lookup process 600, the entity-level topics are saved in the signal definition 308 (block 306).

Responsive to the signal definition topic identification service 118 determining that the signal inputs 300 fail to include any company-related terms or that the graph lookup process 600 fails to return any entity-level topics, it is determined if the signal inputs 300 include any keywords provided by the customer (block 309). If so, a keyword to URL service maps each of the keywords to URLs (block 310). In one embodiment, the keyword to URL service may be implemented by calling a supplemental service, such as Bing or Google APIs, which returns a set N URLs found to be most relevant to each of the keywords, where N=5-15 in one embodiment.

Any keywords, PDFs or URLs provided by the customer and the URLs mapped from the keywords are stored in a repository for classification (block 312).

A classification service scrapes and extracts content from the PDFs and URLs and matches the content to relevant topics from the topic taxonomy 128 (block 314). According to one aspect of the disclosed embodiments, the classification service first classifies the extracted content as business-to-business (B2B) content, and then matches only the B2B content to relevant topics from the topic taxonomy to reduce the chance of including topics that are irrelevant to the customer's business.

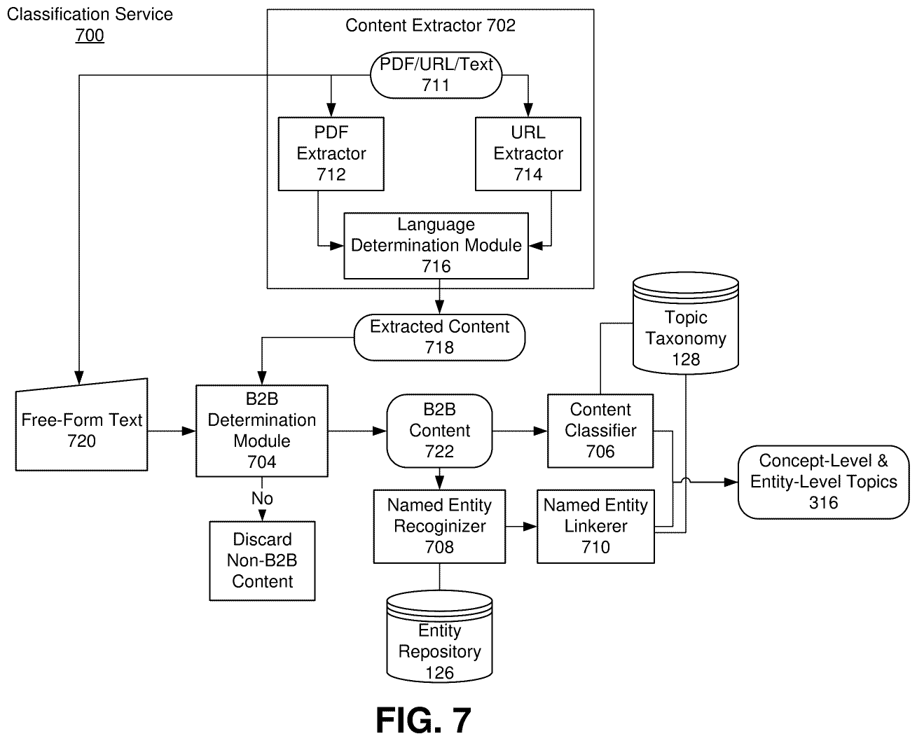

FIG. 7 is a diagram illustrating components of, and the processing performed by, the classification service. In one example embodiment, the classification service 700 may include components such as a content extractor 702, a B2B determination module 704, a content classifier 706, a named entity recognizer 708, and a named entity linker 710. The content extractor 702 may comprise a PDF extractor 712, a URL extractor 714, and a language determination module 716. Alternatively, the PDF extractor 712 and the URL extractor 714 may be implemented as a signal engine.

The B2B determination module 704, the content classifier 706, the named entity recognizer 708, and the named entity linker 710 may be implemented as NLP/NLU engines that create word embeddings from text input to capture semantic meanings and to enable efficient computation. Word embeddings are representations of words that are used in text analysis. They are dense vectors of real numbers in a high-dimensional space, where most entries are not zero. Any suitable of word embedding technique may be used, such as BERT, Word2Vec, GloVe, Embedding Layer, Bag of Words (BoW) and the like.

In operation, the content extractor 702 receives PDF/URL/text 711 from the signal inputs 300. The PDF extractor 712 may be called to extract content/text from the PDFs, while the URL extractor 714 scrapes and extracts content/text from the URLs. The language determination module 716 may be implemented as a probabilistic model and outputs a probability or likelihood that the content comprises English content or non-English language content. If the language determination module 716 determines that the content is in a non-English language, the content may be discarded, or any suitable language translation model may be used to translate the non-English content into English. The content extractor 702 may be implemented as Kubernetes apps or engines.

Content comprising the free-form text 720 input by the customer and the extracted content 718 are input to the B2B Determination model 704. The B2B determination model 704 is a feature-learning algorithm that classifies each content item into one of two categories, B2B/business content 722 and nonbusiness content.

B2B content 722 refers to information and materials that are directly related to commercial activities, industries, companies, products, or services. This type of content is typically created and published by businesses, organizations, or individuals for professional or commercial purposes. Examples of business content may include: i) Company websites: Information about products, services, pricing, company history, team members, and contact details; ii) Product catalogs and descriptions: Detailed specifications, features, and images of products or services offered by a business; iii) Industry reports and analysis: Market research, trend analysis, and insights related to specific industries or sectors; iv) Job listings and career resources: Information about job openings, career advice, and professional development resources; v) Business news and articles: News, analysis, and commentary related to companies, industries, markets, and the economy; and iv) Business directories and listings: Contact information, profiles, and details of various businesses and service providers.

Non-business content refers to information and materials that are not primarily focused on commercial activities or industries. This type of content is typically created and published for personal, educational, entertainment, or informational purposes. Examples of non-business content may include: i) Personal blogs and social media posts: Opinions, experiences, and stories shared by individuals on various topics; ii) Educational resources: Textbooks, course materials, tutorials, and instructional content for learning purposes; iii) News and media articles: Current events, politics, sports, entertainment, and general interest news stories; iv) Online forums and discussion boards: User-generated discussions and conversations on various topics; v) Entertainment content: Movies, TV shows, music, games, and other forms of online entertainment; and vi) Government and public sector information: Laws, regulations, policies, and information from government agencies and organizations.

It is important to note that while this categorization provides a general distinction between business and non-business content, there can be overlaps or gray areas where certain types of content may fall into both categories or serve multiple purposes. The B2B determination model may be fine-tuned as desired to handle such cases.

The extracted B2B content 722 is input to the content classifier 706 and the named entity recognizer 708.

The content classifier 706 classifies text from the B2B content into concept-level topics stored in the topic taxonomy 128. In general, the concept-level topics stored in the topic taxonomy 128 relate to concepts such as problems/issues and potential solutions. In one embodiment, the content classifier 706 searches the topic taxonomy 128 with the B2B content 722 and assigns the B2B content to one or more concept-level topics from the topic taxonomy 128 having a description that most closely matches the B2B content 722. The entity classifier 706 may assign a confidence score indicating a degree to which concept-level topics are related to the B2B content 722. In one embodiment, the content classifier 706 may be implemented as a fine-tuned Bert NLP model.

The named entity recognizer 708 and the named entity linker 710 work in conjunction to classify the B2B content 722 into entity-level topics that are relevant to the customer's company, product or service. In one embodiment, the named entity recognizer 708 and the named entity linker 710 may be implemented as one model.

The named entity recognizer 708 first classifies the extracted B2B content 722 as including one or more named entities related to a proper name of a company or product. In one embodiment, the named entity recognizer 708 calculates the probability or likelihood that the extracted B2B content 722 includes one or more proper names that are stored in the entity repository 126. The entity repository 126 stores terms that can be considered company-related proper names, including company names, product names, legal terms, legal firms, people, locations, and digits. In one embodiment, the entity repository 126 may track company-related proper names for millions of entities.

Responsive to the extracted B2B content 722 being classified as including one or more named entities, the named entity linker 710 classifies the named entities into entity-level topics that are relevant to the customer's company, product, or other relevant and determines which of the named entities are not relevant to the customer. In one embodiment, the named entity linker 710 searches concept taxonomy 128 with the one or more named entities and outputs one or more entity-level topics from the topic taxonomy 126 associated with the one or more named entities. The named entity linker 710 may assign a confidence score indicating a degree to which entity-level topics are associated with the named entities.

For example, consider that the company name provided by the customer 104 is “YYY” Corp. Assume further that there are twenty-five companies that contain “YYY”. The named entity linker 710 inputs the different B2B content about the company or product “YYY”, from websites containing “YYY”, and any customer-provided description of “YYY”, and classifies each one individually as being relevant to topics concerning the company “YYYY” or products thereof, or not.

Finally, the classification service 700 combines the concept-level topics and the entity-level topics and outputs a combination of the concept-level and entity-level topics 316.

Referring again to FIG. 3A, the concept-level and entity-level topics 316 output by the classification service 700 include the concept-level topics and the entity-level topics that are predicted to be relevant to the B2B content extracted from the customer's PDF, URLs, and text.

The signal definition topic identification service 118 then invokes the graph lookup process 600 (block 318) to determine whether any of the concept-level topics and the entity-level topics 316 are relevant (linked) to any additional topics in the topic taxonomy 128.

If the graph lookup process 600 returns additional topics, then the signal definition topic identification service adds the list of topics output by the classification service and the additional topics to the signal definition (block 320).

If the graph lookup process fails to return any additional topics, the signal definition topic identification service 118 invokes the graph inference process (block 322) to identify additional topics that are predicted to be relevant concept-level topics and named entity topics based on graph relationships.

FIG. 6B is a flow diagram showing a process performed by the graph inference process to find a set of additional topics that are predicted to be relevant concept-level topics and named entity topics according to one embodiment.

The graph inference process 620 first adds the customer name and/or product/service name as nodes in the taxonomy graph (block 622) and adds links to concept-level topics to which the product/service name is related (block 624). The graph lookup inference 620 then infers competitor companies based on concept-level topics 608 that are shared. Specifically, it is inferred that another company is a competitor of the customer by determining whether any of the other companies has a product that is linked to the related concept-level topics (block 626). The graph inference process 620 outputs these concept-level topics that are shared as inferred relevant topics of the customer (block 628).

Referring to FIG. 5B, as an example assume that the customer of the intent signal builder service is company D and that company D and their Product 5 were not originally present in the topic taxonomy. But as Company D recently provided the signal Inputs 300, the intent signal data builder service 114 adds nodes for Company D and their Product 5 to the taxonomy graph. The signal definition topic identification service 118 identifies that Product 5 is relevant or related to topics X, Y, and Z and adds corresponding links to the taxonomy graph. Then, based on the relevant topics, the graph inference process predicts or infers that Company C is a competitor of Company D because Company C's Product 4 and Company D′s Product 5 are shared with or linked to topics X, Y, and Z. Topics X, Y, and Z are then output as inferred relevant topics to company D.

Referring again to FIG. 3A, if the graph inference process returns any inferred relevant topics, then the signal definition topic identification service adds the inferred relevant topics to the signal definition 308 (block 324).

If the graph inference process fails to return any additional topics, the signal definition topic identification service invokes a similarity algorithm (block 326). Based on topics in the signal definition 308, the similarity algorithm suggests an additional set of similar topics from the topic taxonomy (block 326).

For example, it may be straightforward to determine that topics for HR and Human Resources and Human Capital Management are very similar. But it's much harder to determine that companies named Workday, ADP, and Human Capital Management are in the same area or related to each other.

Each of the topics produced above includes a text description and an embedding of the text description. The topic taxonomy may also contain embeddings for all the included topics.

In one embodiment, the similarity algorithm is an NLP/NLU model that can determine the similarity between topics based on a co-occurrence algorithm and embedding similarity. Based on existing returned topics, the similarity algorithm suggests similar topics based on a co-occurrence algorithm that determines which topics very frequently occur on the same pages-a frequency calculation and embedding similarity are determined by running the topic embeddings through a machine learning model.

The output is an additional list of topics, along with a corresponding similarity confidence score indicating the degree of similarity of the topic to the group of topics of signal definition 308. The similarity confidence score may be a probability of 0 to 1 that the new topic is similar to the group of topics, not to the individual topics. Each additional similar topic also has a corresponding relevancy score indicating the topic's relevancy to the source content (e.g., URL/page/PDF/keyword). For example, the relevancy score may indicate a probability of 0.9 that the topic is attached to the page. The relevancy to the page may represent the quality of the prediction.

### Topic Ranking Service

Referring still to FIG. 3A, the topic ranking service 120 inputs topics from the signal definition 308 and from the similarity algorithm acquired from different URLs, different PDFs and keywords. The topic ranking service 120 outputs a ranked set of topics that are most relevant to the customer or customer's product ordered by the highest relevancy to the company/domain and the products/services that the customer is offering. Less likely relevant topics may be removed from the ranked set of topics based on a threshold.

Additionally or alternatively, the topic ranking service 120 may perform the following process:
1) Combine the Keyword to URLS and URL/PDF topic classifications and compute the sum of the relevancy by topic: rlcy_sum
2) Remove topics that were assigned to only one keyword or URL/PDF.
3) Create a subset of all returned topics to be used as “reference topics” using a reference topic threshold max_rlcy>0.7.
4) Using the reference topic subset (topic_1), group by the comparison topic (topic_2) then compute the sum of each topic's similarity scores (co-occurrence) and select all topics with a similarity score sum>=0.01 to create top_co_occurring_topics. In one embodiment a non-scaled co-occurrence value is used as scaling may increase the impact of topics that co-occur with many other topics (ex. Amazon, AWS, and Google).

5) Inner join the top_co_occurring_topics with the list of topics from step 2 to create joined_top_co_occurring_topics.
6) Return all reference topics (topics with max relevancy>0.7) and the topics from step 5: max_rlcy>0.7 OR topics in joined_top_co_occurring_topics
7) Order the list of topics by the sum of the relevancy (rlcy_sum) descending and update the signal definition 308.

This process utilizes two main thresholds: i) the threshold for topics to be used as “reference topics”. A reference topic is a topic used as the key in the similarity. Similar topics are retrieved based on this topic. This threshold refers to selecting the topics that produce the most similar topics. ii) a threshold for limiting the number of similar topics to return.

According to the disclosed embodiments, the sum of a topic's relevancy is used as a strong predictor of whether a topic will be added to signal definition 308. This information may be combined with co-occurrence/similarity to ensure that the topic ranking system only return topics related to the topics with the highest relevancy. The goal is to reduce the number of topics on the final signal definition 308 that will not be accepted by the customer due to irrelevancy.

The final process of the signal definition topic identification service 118 is to output the signal definition 308.

Referring now to FIG. 3B, the process proceeds to the intent signal creator service, which generates and outputs the intent signal 124.

### Intent Signal Creator Service

In one embodiment, the intent signal creator service 122 may begin by displaying the signal definition 308 in the topic curation dashboard UI 116A to the customer 104 (block 336). The signal definition 308 may be displayed as a list of topics ranked by relevancy from highest to lowest. The number of topics selected and the number of topics displayed may be controlled quantitatively or through threshold scoring. For example, a topic-generated threshold may be set to limit the number of topics selected (e.g. 100-150), while a topic display threshold may be set to limit the number of topics displayed (e.g., 10-30).

The topic curation dashboard UI 116A displays an option for the user to either accept all provided topics, decline any or all topics, or select additional topics proposed by the topic similarity service and or provide their own topics to ensure relevant topics are not missing and that irrelevant topics are not included. Enabling the customer to customize the final topic list may be important for improving the performance of implementing the customer's sales and marketing goals. After finalizing the list of topics, the customer clicks “Save” or “Next” to begin segmentation. Segmentation

In one aspect of the disclosed embodiments, the final stage of the Intent signal builder service is segmentation, which uses customer provided/selected segmentation data/criteria to define the customer's addressable market for their products/services. In this stage, the topic curation dashboard UI 116A displays areas for the customer to select segmentation data and/or upload the segmentation data. For example, the segmentation data may be uploaded via CSV or XLSX file for example. The topic curation dashboard UI 116A may display areas for the user to enter segmentation data after the user selects the final topic list and/or as part of the signal inputs 300. In one embodiment the segmentation data includes: a list of target company accounts referred to as a Target Account List (TAL), Employee Size, Revenue, Industry, and Geography. Optionally, the customer may enter information about their goals as segmentation data if not provided as part of the signal inputs 300.

One option is for the customer to optionally provide a list of target company accounts to suppress or to target against. This is beneficial if the customer only wants information about the specific account list or clients or rather wants information about every company except for the specific account list. This is a fundamental step in several customer goals or use cases such as churn prevention, upselling, key accounts profiling, and the like.

The intent signal creator service 122 filters the ranked set of topics from the signal definition 308 that fall into segment levels of any provided segmentation data to generate a filtered set of ranked topics (block 338).

For example, the entity repository 126 may store information about entities and may include firmographic data associated with the entities, such as region, country as well as industry revenue, company size, and company name. After signal definition generation, the customer enters segmentation data that limits the data to North America, for example. In this case, only information about North American companies are retrieved from the entity repository 126.

The intent signal creator service 122 searches for the topics from the signal definition to find matches in the entity profile repository 130 topics with target topics for which the target company has shown interest (block 340). The target topics may have corresponding topic interest score indicating an interest level. Only those topics from the signal definition that are associated with the target company are analyzed further and only companies from the TAL list that actually have intent to buy with the topics are analyzed. In absence of a target account list (TAL) each topic in the signal definition may be assigned a list of zero or more target companies that exhibit an interest or intent in buying that particular product at different levels.

The matching topics are then associated with the corresponding topic interest scores from the target topics (block 342). The buying funnel stage that the target company is currently in is identified for each of the matching topics, and the buying funnel stages are associated with respective ones of the matched topics (block 344). In one embodiment, the current buying funnel stage of the target customer is determined for the matching filtered topics based on an acceleration of online research frequency and depth of engagement in that topic by the target company during the different buying funnel stages.

The intent signal data creator 122 aggregates the returned topic interest scores associated with the matching of topics from the signal definition and creates one unified intent signal score that represents the interest level of the target company of the matching topics original set of topics from the signal definition (block 346).

According to the disclosed embodiments, the intent signal score gauges not only the number of matched topics and individual topic interest scores, but may also utilizes segmentation data to align or realign the two attributes, the number of topics and the individual topic score relative to the cohort of similar companies.

In sum, the system uses the extracted content to generate a set of the relevant topics and scores and filters the set of topics based on the segmentation data. Then the system goes into the searches the entity profile repository 130 that contains every topic and every company, retrieves only the target topics of the target companies that have displayed an interest in the filtered set of topics to produce a final set of topics for the intent signal.

### Buying Funnel Stages in Further Detail

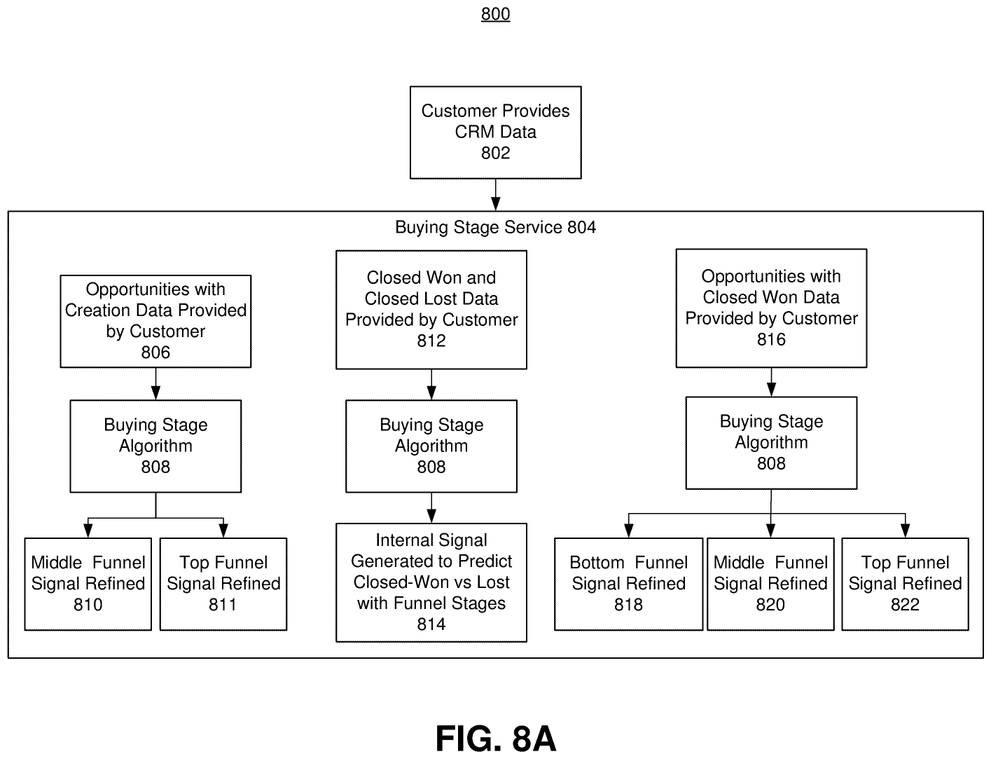

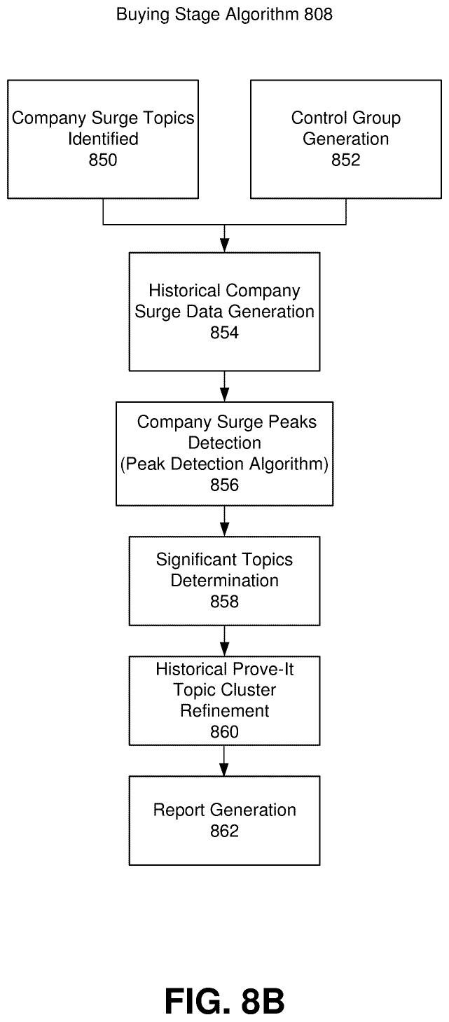

FIG. 8A is a diagram illustrating a process of determining buying funnel stages. In a one embodiment, further historical context analysis related to buying funnel stages is used to create the intent signal.

The first use case is that the customer is not willing to provide any of their CRM data. So the system performs the analysis only from the data the system collects and the inference on the general behaviors of topics in the different funnel stages. For example, very highly researched topics or topics about a problem are typically located in the top stage of the funnel. Topics about the solution are typically located in the middle stage of the funnel. Topics about the competitors are typically located at the bottom stage of the funnel. This is a very general observation from the vast amount of data the system has analyzed.

The process 800 illustrates the second use case where the customer provides CRM data 802 describing closed lost deals or closed won deals for all customer accounts. In the context of CRM data 802, the term “accounts” typically refers to companies or organizations with whom the customer has a relationship. The CRM data or list of accounts is input to an ML buying stage service 804 system for analysis corresponding to block 344 of FIG. 3B. If the customer provides CRM data 802 with the closed and lost data for each of its accounts, the buying stage service 804 examines and aligns each of the accounts to a respective zero moment. The zero moment is either the opportunity creation date or the opportunity finalized date (closed date) for each account. If it's the opportunity open date, then the system aligns its data by looking starting its analyses starting from that date minus some number of weeks (e.g., 1, 2, . . . 72 weeks) and determining which topics were of interest to the target company during that time period.

The buying stage service 804 processes three different types of opportunities data in parallel. On the left side, creation data opportunities 806 are processed through a buying stage algorithm 808, which generates two outputs: a middle funnel signal 810 and a top funnel signal 811. In the center path, closed data opportunities 812 flow through the buying stage algorithm 808 to an internal signal generator 814 that predicts closed-won versus lost opportunities with funnel stages. On the right side, closed data provider 816 connects to the buying stage algorithm 808, which outputs three signals: a bottom funnel signal 818, a middle funnel signal 820, and a top funnel signal 822.

The buying stage service 804 contains multiple parallel processing paths that handle different types of opportunity data through the buying stage algorithm 808. Each path produces specific funnel signals that correspond to different stages in the buying process.

The system fits the topics of interest into the different use cases that can be treated differently. Some of the topics are aligned to the top, middle, and bottom stages of the funnel and require historical analysis.

FIG. 8B illustrates a flowchart of a buying stage algorithm 808 shown in FIG. 8A. The buying stage algorithm 808 begins with two parallel steps: identify company surge topics (block 850) and generate a control group (block 852). In company surge topics identification (block 850), content about the customer and its products is gathered and generated, and customer surge topics are aligned to the products. The control group generation (block 852) leverages opportunities provided by the customer to identify companies matching the customer's ideal customer profile.

Following these initial steps, the buying stage algorithm 808 proceeds with historical company surge data generation (block 854), where historical lookback data is generated for all identified topics across a specified timeframe (typically X weeks) for each opportunity provided. The closed-won dates are unique per opportunity, with alignment using closed-won minus week X logic, described above. This step aligns all accounts to a single timeline for analysis.

Next, the company surge peaks detection (block 856) processes the company surge data aligned across opportunities, employing relative scores to determine overall spikes in research. This is followed by significant topics determination (block 858), which compares research trends between provided opportunities and the control group to identify historically significant research topics.

Historical prove-it topic cluster refinement (block 860) takes the significant topics identified during peak periods and determines which minimal set of topics would have most effectively separated targets and controls based on historical company surge reports. This step optimizes the topic selection to ensure precision and relevance.

The historical analysis is used to refine/adjust the topic interest scores (TIS). The topic interest scores are produced in different manners. If the customer desires to utilize the target company's buying journey, then that is the process that is used before creation of the intent signal.

The process creates an intent signal that is specific to, and identifies behaviors relevant to, each of the buying stages for each of the groups of topics of interest. To do so, the process starts with locating topics that are significant for identifying a target company that is researching the purchase of the customers' product, and then determining at which buying funnel stage the prospect is in. Furthermore, the buying stage service 804 associates each of these topics with a stage/location in the buying funnel. This gives typically located customers insight into exactly where their target company is in the buyers' journey, and allows the customer to serve a relevant message to sway their prospect towards the customer's products and services.

According to one embodiment, using CRM data stratified by country, industry, company size (defined by annual revenue & number of employees), and the historical buyer's journey patterns are analyzed for 72 weeks prior to the zero date.

The buying stage algorithm 808 identifies a certain number of anomalous spikes in research by the target company to map to peaks. If provided open and closed dates, the peaks are aligned given this information.

For each of the 72 weeks, the topic interest scores (TIS) are aggregated for each group of target accounts based on each topic in the signal definition. For each week, a T-test is calculated for the means of two independent samples of scores. A statistical T-test is a hypothesis test used to determine if there is a significant difference between the means of two groups.

This is a test for the null hypothesis that 2 independent samples have identical average (expected) values. This test assumes that the populations have identical variances by default. In this case, the population is all opportunities and samples, such as closed-won vs closed-lost opportunities. The statistical power for each t-test is calculated for two independent samples in order to determine the minimum number of samples needed in order to accept the t-test. If one of the two samples of scores has enough of the target company accounts to meet a power of 0.65, then it is accepted that there is a statistically significant difference between the 2 samples for a given week.

Then the buying stage algorithm 808 aggregates the anomalous spike data with the data that indicates where the two groups of target company accounts have a significant difference in TIS scores per topic to determine which spikes align with significant topics. This provides insights into what topics have a significant difference between the two groups of target company accounts over the 72-week period.

The process concludes with report generation (block 862) in which images and metrics are generated and compiled into a report for viewing by the customer. The report includes visualizations and metrics showing research trends of significant topics and displays the percentage of closed-won and potential opportunities that appeared on historical company surge reports.

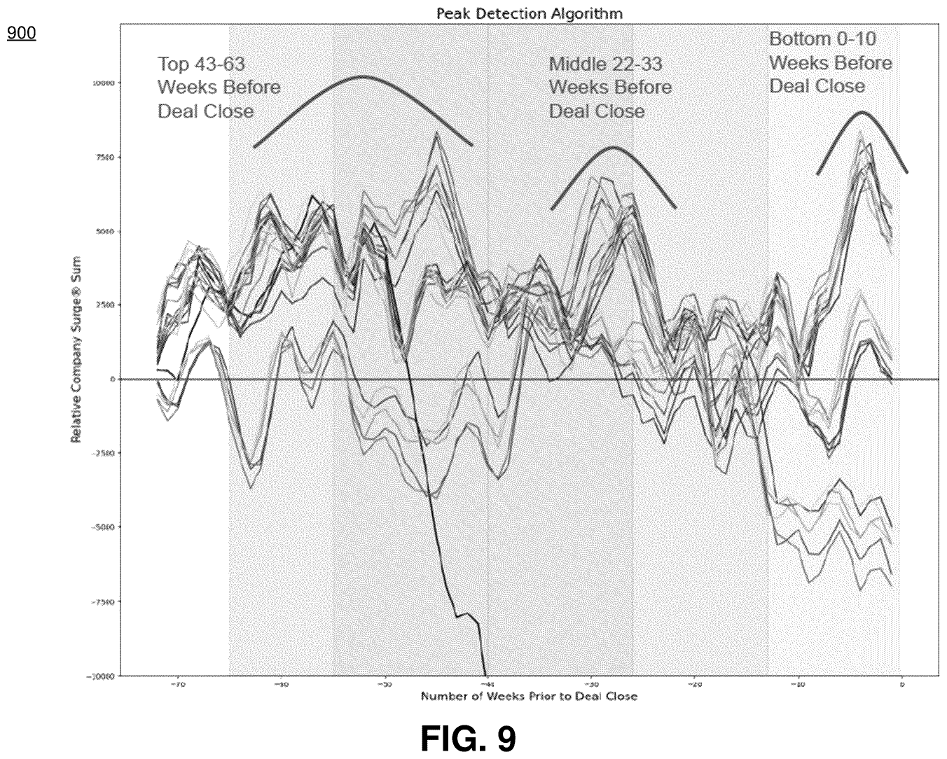

FIG. 9 is a diagram illustrating an example buying stages graph. The buying stages graph 900 maps various topics (listed on the right) to buying funnel stages and may be included in the report generated in block 862. The buying stages graph 900 identifies three stages: Top, Middle, and Bottom, and 3 spikes in the Top, Middle, and Bottom of the buying funnel stages. In one embodiment, the buying stages graph 900 is an example where timelines differ for each signal. In this example, the Top represents 43-63 weeks before deal close, the Middle represents 22-23 weeks before deal close, and the Bottom represents 0-10 weeks before deal close.

The buying stages graph 900 shows times when the target company accounts won deals, and when they have very minimal research on a variety of topics, which is called baseline research. Light colored interest-level lines in the buying stages graph 900 show the interest level of the target accounts, where spikes in the lines indicate strong interest and troughs indicate low interest. By analyzing the three spikes, topics can be delineated that dominate each period of time.

The buying stage service 804 has the ability to find the high-interest topics that are significantly more predictive and typically spike earlier in the life cycle. After spiking in the Top of the funnel, the target accounts move on and research after one period of time, stop researching, indicated by a dip in the interest-level line, and then start back up after another period of time, indicated by a rise in the interest-level line. The dips and rises are different at different times before the close, as shown in the Middle and Bottom stages.

The buying stage service 804 analyzes the buying journey of one or more target companies of the customer and can determine when the target companies are actively researching a solution to a problem and showing a high-level of interest in the customer's products/services for the solution. The ability to identify which topics dominate and when is a very nontrivial problem. It heavily dependent on behavioral data and the system's ability to track and trace that behavior over time. The funnel stages analysis identifies which ones among all these topics the target is most interested and, which ones are in the top, middle, and bottom, and which ones align with the goal of the customer. This analysis is used to adjust/generate topic interest scoring and affects the intent signal score that is generated.

### Intent Signal Output

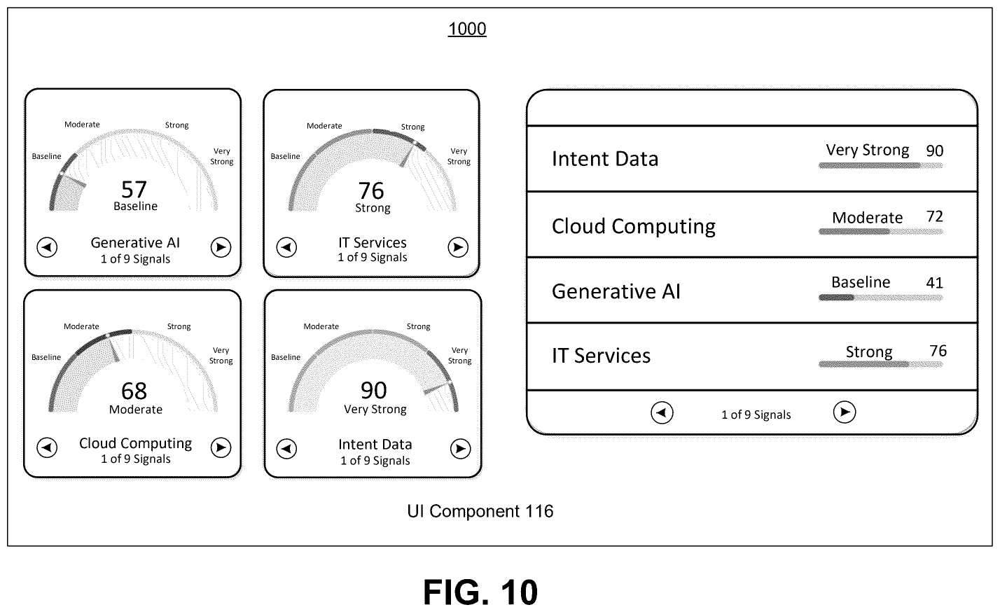

FIG. 10 is a diagram illustrating an example Intent signal. The intent signal 1000 includes a list of one or more target companies 1002, each of which is represented by the company name and optionally other supplemental details such as industry revenue, company size, and the like, and a list of topics 1004 for which the account has shown interest. Prior solutions merely provide data for one topic, rather than a group of topics

Each listed topic associated for the target company includes a numeric signal score 1006 indicating an interest level and a signal strength grade 1008. In another embodiment, each record may include a single numeric score that is aggregated across the topics (not shown).

The signal strength grade 1008 is a multi-level non-numeric that aligns with the signal score because, realistically speaking, there are different levels of intent data. The signal strength grade is associated with the signal score. The signal strength grades may include “Extremely Strong”, “Very strong”, “Strong”, “Moderate”, and “Baseline” depending on where the signal scores fall along the range of possible domain scores.

Extremely strong A: This grade may be associated with a signal score greater than 90%, for example. Very strong A: This grade may be associated with a signal score of 80%-89%, for example. Strong: This grade may be associated with a signal score of 70-79%, for example. Moderate: This grade may be associated with a score within the range of 60-69%, for example. Baseline: This grade may be associated with a domain score within the range of 35%-59%, for example. Based on the signal score 1006 and the signal strength grade 1008, the customer 104 may provide different levels of outreach to the target company 112 depending on whether the score is a 62 or 95, for example. The signal strength grade 1008 may be most applicable to the customers who are sellers.

In one embodiment, the UI component 116 provides two methods for delivering the intent signal 124. One is through the UI component 116 itself and the other is through an output API to a CRM application (e.g., Salesforce integration) where the intent signal is displayed through the CRM application.

### Example Hardware and Software Configurations and Implementations

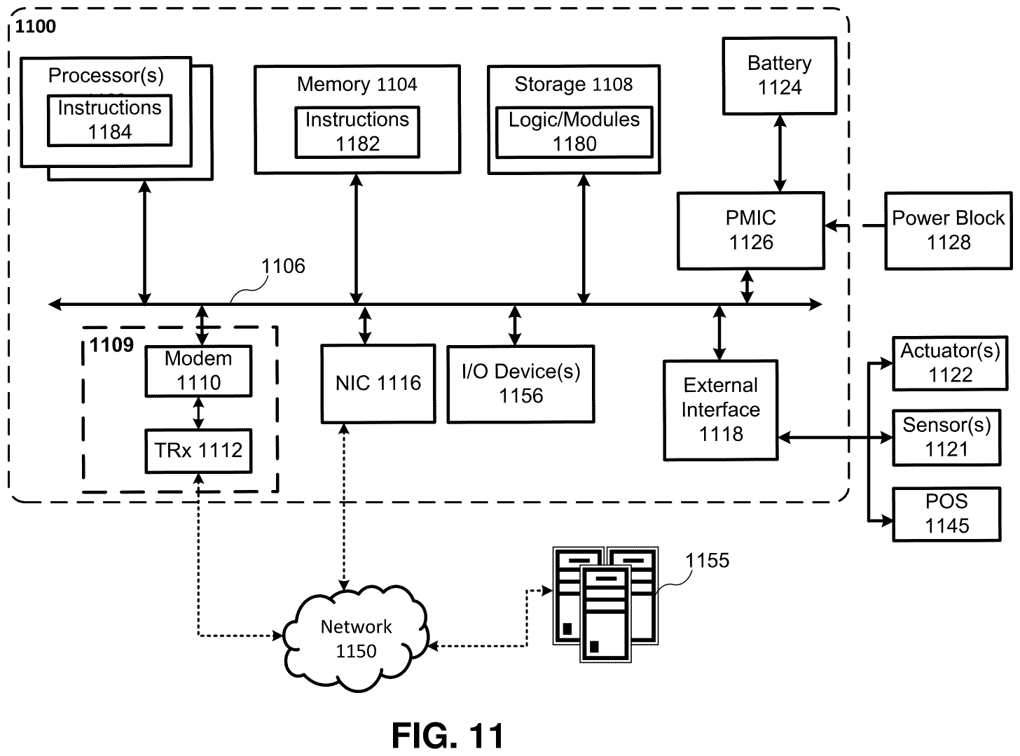

FIG. 11 illustrates an example of a computing system 1100 (also referred to as “computing device 1100,” “platform 1100,” “device 1100,” “appliance 1100,” “server 1100,” or the like) in accordance with various embodiments. The computing system 1100 may be suitable for use as any of the computer devices discussed herein and performing any combination of processes discussed above. As examples, the computing device 1100 may operate in the capacity of a server or a client machine in a server-client network environment, or as a peer machine in a peer-to-peer (or distributed) network environment. Additionally or alternatively, the system 1100 may represent the CCM IG. 102, user computer(s), a network device and/or network appliance, application server(s) (e.g., owned/operated by customers 104), a third-party platform or collection of servers that hosts and/or serves information objects IG. 110, and/or any other system or device discussed previously. Additionally or alternatively, various combinations of the components depicted by FIG. 11 may be included depending on the particular system/device that system 100 represents. For example, when system 100 represents a user or client device, the system 100 may include some or all of the components shown by FIG. 1. In another example, when the system 100 is the CCM IG. 102 or a server computer system, the system 100 may not include the communication circuitry 109 or battery 124, and instead may include multiple NICs 116 or the like. As examples, the system 100 and/or the remote system 155 may comprise desktop computers, workstations, laptop computers, mobile cellular phones (e.g., “smartphones”), tablet computers, portable media players, wearable computing devices, server computer systems, web appliances, network appliances, an aggregation of computing resources (e.g., in a cloud-based environment), or some other computing devices capable of interfacing directly or indirectly with network 150 or other network, and/or any other machine or device capable of executing instructions (sequential or otherwise) that specify actions to be taken by that machine.

The components of system 100 may be implemented as an individual computer system, or as components otherwise incorporated within a chassis of a larger system. The components of system 100 may be implemented as integrated circuits (ICs) or other discrete electronic devices, with the appropriate logic, software, firmware, or a combination thereof, adapted in the computer system 100. Additionally or alternatively, some of the components of system 100 may be combined and implemented as a suitable System-on-Chip (SoC), System-in-Package (SiP), multi-chip package (MCP), or the like.

The system 100 includes physical hardware devices and software components capable of providing and/or accessing content and/or services to/from the remote system 155. The system 100 and/or the remote system 155 can be implemented as any suitable computing system or other data processing apparatus usable to access and/or provide content/services from/to one another. The remote system 155 may have a same or similar configuration and/or the same or similar components as system 100. The system 100 communicates with remote systems 155, and vice versa, to obtain/serve content/services using, for example, Hypertext Transfer Protocol (HTTP) over Transmission Control Protocol (TCP)/Internet Protocol (IP), or one or more other common Internet protocols such as File Transfer Protocol (FTP); Session Initiation Protocol (SIP) with Session Description Protocol (SDP), Real-time Transport Protocol (RTP), or Real-time Streaming Protocol (RTSP); Secure Shell (SSH), Extensible Messaging and Presence Protocol (XMPP); WebSocket; and/or some other communication protocol, such as those discussed herein. In some examples, the events IG. 108 may be or include session events defined by any of the aforementioned protocols.

As used herein, the term “content” refers to visual or audible information to be conveyed to a particular audience or end-user, and may include or convey information pertaining to specific subjects or topics. Content or content items may be different content types (e.g., text, image, audio, video, etc.), and/or may have different formats (e.g., text files including Microsoft® Word® documents, Portable Document Format (PDF) documents, HTML documents; audio files such as MPEG-4 audio files and WebM audio and/or video files; etc.). As used herein, the term “service” refers to a particular functionality or a set of functions to be performed on behalf of a requesting party, such as the system 100. As examples, a service may include or involve the retrieval of specified information or the execution of a set of operations. In order to access the content/services, the system 100 includes components such as processors, memory devices, communication interfaces, and the like. However, the terms “content” and “service” may be used interchangeably throughout the present disclosure even though these terms refer to different concepts.

Referring now to system 100, the system 100 includes processor circuitry 102, which is configurable or operable to execute program code, and/or sequentially and automatically carry out a sequence of arithmetic or logical operations; record, store, and/or transfer digital data. The processor circuitry 102 includes circuitry such as, but not limited to one or more processor cores and one or more of cache memory, low drop-out voltage regulators (LDOs), interrupt controllers, serial interfaces such as serial peripheral interface (SPI), inter-integrated circuit (I²C) or universal programmable serial interface circuit, real time clock (RTC), timer-counters including interval and watchdog timers, general purpose input-output (I/O), memory card controllers, interconnect (IX) controllers and/or interfaces, universal serial bus (USB) interfaces, mobile industry processor interface (MIPI) interfaces, Joint Test Access Group (JTAG) test access ports, and the like. The processor circuitry 102 may include on-chip memory circuitry or cache memory circuitry, which may include any suitable volatile and/or non-volatile memory, such as DRAM, SRAM, EPROM, EEPROM, Flash memory, solid-state memory, and/or any other type of memory device technology, such as those discussed herein. Individual processors (or individual processor cores) of the processor circuitry 102 may be coupled with or may include memory/storage and may be configurable or operable to execute instructions stored in the memory/storage to enable various applications or operating systems to run on the system 100. In these embodiments, the processors (or cores) of the processor circuitry 102 are configurable or operable to operate application software (e.g., logic/modules 180) to provide specific services to a user of the system 100. In some embodiments, the processor circuitry 102 may include special-purpose processor/controller to operate according to the various embodiments herein.

In various implementations, the processor(s) of processor circuitry 102 may include, for example, one or more processor cores (CPUs), graphics processing units (GPUs), Tensor Processing Units (TPUs), reduced instruction set computing (RISC) processors, Acorn RISC Machine (ARM) processors, complex instruction set computing (CISC) processors, digital signal processors (DSP), programmable logic devices (PLDs), field-programmable gate arrays (FPGAs), Application Specific Integrated Circuits (ASICs), SoCs and/or programmable SoCs, microprocessors or controllers, or any suitable combination thereof. As examples, the processor circuitry 102 may include Intel® Core™ based processor(s), MCU-class processor(s), Xeon® processor(s); Advanced Micro Devices (AMD) Zen® Core Architecture processor(s), such as Ryzen® or Epyc® processor(s), Accelerated Processing Units (APUs), MxGPUs, or the like; A, S, W, and T series processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); Power Architecture processor(s) provided by the OpenPOWER® Foundation and/or IBM®, MIPS Warrior M-class, Warrior I-class, and Warrior P-class processor(s) provided by MIPS Technologies, Inc.; ARM Cortex-A, Cortex-R, and Cortex-M family of processor(s) as licensed from ARM Holdings, Ltd.; the ThunderX2® provided by Cavium™, Inc.; GeForce®, Tegra®, Titan X®, Tesla®, Shield®, and/or other like GPUs provided by Nvidia®; or the like. Other examples of the processor circuitry 102 may be mentioned elsewhere in the present disclosure.

In some implementations, the processor(s) of processor circuitry 102 may be, or may include, one or more media processors comprising microprocessor-based SoC(s), FPGA(s), or DSP(s) specifically designed to deal with digital streaming data in real-time, which may include encoder/decoder circuitry to compress/decompress (or encode and decode) Advanced Video Coding (AVC) (also known as H.264 and MPEG-4) digital data, High Efficiency Video Coding (HEVC) (also known as H.265 and MPEG-H part 2) digital data, and/or the like.

In some implementations, the processor circuitry 102 may include one or more hardware accelerators. The hardware accelerators may be microprocessors, configurable hardware (e.g., FPGAs, programmable ASICs, programmable SoCs, DSPs, etc.), or some other suitable special-purpose processing device tailored to perform one or more specific tasks or workloads, for example, specific tasks or workloads of the subsystems of the CCM IG. 102 and/or some other system/device discussed herein, which may be more efficient than using general-purpose processor cores. In some embodiments, the specific tasks or workloads may be offloaded from one or more processors of the processor circuitry 102. In these implementations, the circuitry of processor circuitry 102 may comprise logic blocks or logic fabric including and other interconnected resources that may be programmed to perform various functions, such as the procedures, methods, functions, etc. of the various embodiments discussed herein. Additionally, the processor circuitry 102 may include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 102 may include hardware elements specifically tailored for machine learning functionality, such as for operating the subsystems of the CCM IG. 102 discussed previously with regard to FIG. 3. In these implementations, the processor circuitry 102 may be, or may include, an AI engine chip that can run many different kinds of AI instruction sets once loaded with the appropriate weightings and training code. Additionally or alternatively, the processor circuitry 102 may be, or may include, AI accelerator(s), which may be one or more of the aforementioned hardware accelerators designed for hardware acceleration of AI applications, such as one or more of the subsystems of CCM IG. 102 and/or some other system/device discussed herein. As examples, these processor(s) or accelerators may be a cluster of artificial intelligence (AI) GPUs, tensor processing units (TPUs) developed by Google® Inc., Real AI Processors (RAPS™) provided by AlphalCs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 102 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like.

In some implementations, the processor(s) of processor circuitry 102 may be, or may include, one or more custom-designed silicon cores specifically designed to operate corresponding subsystems of the CCM IG. 100, IP2D resolution system 850, and/or some other system/device discussed herein. These cores may be designed as synthesizable cores comprising hardware description language logic (e.g., register transfer logic, verilog, Very High Speed Integrated Circuit hardware description language (VHDL), etc.); netlist cores comprising gate-level description of electronic components and connections and/or process-specific very-large-scale integration (VLSI) layout; and/or analog or digital logic in transistor-layout format. In these implementations, one or more of the subsystems of the CCM IG. 102 and/or some other system/device discussed herein may be operated, at least in part, on custom-designed silicon core(s). These “hardware-ized” subsystems may be integrated into a larger chipset but may be more efficient that using general purpose processor cores.

The system memory circuitry 104 comprises any number of memory devices arranged to provide primary storage from which the processor circuitry 102 continuously reads instructions 182 stored therein for execution. In some embodiments, the memory circuitry 104 is on-die memory or registers associated with the processor circuitry 102. As examples, the memory circuitry 104 may include volatile memory such as random access memory (RAM), dynamic RAM (DRAM), synchronous DRAM (SDRAM), etc. The memory circuitry 104 may also include nonvolatile memory (NVM) such as high-speed electrically erasable memory (commonly referred to as “flash memory”), phase change RAM (PRAM), resistive memory such as magnetoresistive random access memory (MRAM), etc. The memory circuitry 104 may also comprise persistent storage devices, which may be temporal and/or persistent storage of any type, including, but not limited to, non-volatile memory, optical, magnetic, and/or solid state mass storage, and so forth.

In some implementations, some aspects (or devices) of memory circuitry 104 and storage circuitry 108 may be integrated together with a processing device 102, for example RAM or FLASH memory disposed within an integrated circuit microprocessor or the like. In other implementations, the memory circuitry 104 and/or storage circuitry 108 may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

Storage circuitry 108 is arranged to provide persistent storage of information such as data, applications, operating systems (OS), and so forth. As examples, the storage circuitry 108 may be implemented as hard disk drive (HDD), a micro HDD, a solid-state disk drive (SSDD), flash memory cards (e.g., SD cards, microSD cards, xD picture cards, and the like), USB flash drives, on-die memory or registers associated with the processor circuitry 102, resistance change memories, phase change memories, holographic memories, or chemical memories, and the like.

The storage circuitry 108 is configurable or operable to store computational logic 180 (or “modules 180”) in the form of software, firmware, microcode, or hardware-level instructions to implement the techniques described herein. The computational logic 180 may be employed to store working copies and/or permanent copies of programming instructions, or data to create the programming instructions, for the operation of various components of system 100 (e.g., drivers, libraries, application programming interfaces (APIs), etc.), an OS of system 100, one or more applications, and/or for carrying out the embodiments discussed herein. The computational logic 180 may be stored or loaded into memory circuitry 104 as instructions 182, or data to create the instructions 182, which are then accessed for execution by the processor circuitry 102 to carry out the functions described herein. The processor circuitry 102 accesses the memory circuitry 104 and/or the storage circuitry 108 over the interconnect (IX) 106. The instructions 182 to direct the processor circuitry 102 to perform a specific sequence or flow of actions, for example, as described with respect to flowchart(s) and block diagram(s) of operations and functionality depicted previously. The various elements may be implemented by assembler instructions supported by processor circuitry 102 or high-level languages that may be compiled into instructions 184, or data to create the instructions 184, to be executed by the processor circuitry 102. The permanent copy of the programming instructions may be placed into persistent storage devices of storage circuitry 108 in the factory or in the field through, for example, a distribution medium (not shown), through a communication interface (e.g., from a distribution server (not shown)), or over-the-air (OTA).

The operating system (OS) of system 100 may be a general purpose OS or an OS specifically written for and tailored to the computing system 100. For example, when the system 100 is a server system or a desktop or laptop system 100, the OS may be Unix or a Unix-like OS such as Linux e.g., provided by Red Hat Enterprise, Windows 10™ provided by Microsoft Corp.®, macOS provided by Apple Inc.®, or the like. In another example where the system 100 is a mobile device, the OS may be a mobile OS, such as Android® provided by Google Inc.®, iOS® provided by Apple Inc.®, Windows 10 Mobile® provided by Microsoft Corp.®, KaiOS provided by KaiOS Technologies Inc., or the like.

The OS manages computer hardware and software resources, and provides common services for various applications (e.g., one or more loci/modules 180). The OS may include one or more drivers or APIs that operate to control particular devices that are embedded in the system 100, attached to the system 100, or otherwise communicatively coupled with the system 100. The drivers may include individual drivers allowing other components of the system 100 to interact or control various I/O devices that may be present within, or connected to, the system 100. For example, the drivers may include a display driver to control and allow access to a display device, a touchscreen driver to control and allow access to a touchscreen interface of the system 100, sensor drivers to obtain sensor readings of sensor circuitry 121 and control and allow access to sensor circuitry 121, actuator drivers to obtain actuator positions of the actuators 122 and/or control and allow access to the actuators 122, a camera driver to control and allow access to an embedded image capture device, audio drivers to control and allow access to one or more audio devices. The OSs may also include one or more libraries, drivers, APIs, firmware, middleware, software glue, etc., which provide program code and/or software components for one or more applications to obtain and use the data from other applications operated by the system 100, such as the various subsystems of the CCM IG. 102 and/or some other system/device discussed previously.

The components of system 100 communicate with one another over the interconnect (IX) 106. The IX 106 may include any number of IX technologies such as industry standard architecture (ISA), extended ISA (EISA), inter-integrated circuit (I²C), an serial peripheral interface (SPI), point-to-point interfaces, power management bus (PMBus), peripheral component interconnect (PCI), PCI express (PCle), Intel® Ultra Path Interface (UPI), Intel® Accelerator Link (IAL), Common Application Programming Interface (CAPI), Intel® QuickPath Interconnect (QPI), Intel® Omni-Path Architecture (OPA) IX, RapidIO™ system interconnects, Ethernet, Cache Coherent Interconnect for Accelerators (CCIA), Gen-Z Consortium IXs, Open Coherent Accelerator Processor Interface (OpenCAPI), and/or any number of other IX technologies. The IX 106 may be a proprietary bus, for example, used in a SoC based system.

The communication circuitry 109 is a hardware element, or collection of hardware elements, used to communicate over one or more networks (e.g., network 150) and/or with other devices. The communication circuitry 109 includes modem 110 and transceiver circuitry (“TRx”) 812. The modem 110 includes one or more processing devices (e.g., baseband processors) to carry out various protocol and radio control functions. Modem 110 may interface with application circuitry of system 100 (e.g., a combination of processor circuitry 102) for generation and processing of baseband signals and for controlling operations of the TRx 112. The modem 110 may handle various radio control functions that enable communication with one or more radio networks via the TRx 112 according to one or more wireless communication protocols. The modem 110 may include circuitry such as, but not limited to, one or more single-core or multi-core processors (e.g., one or more baseband processors) or control logic to process baseband signals received from a receive signal path of the TRx 112, and to generate baseband signals to be provided to the TRx 112 via a transmit signal path. In various embodiments, the modem 110 may implement a real-time OS (RTOS) to manage resources of the modem 110, schedule tasks, etc.

The communication circuitry 109 also includes TRx 112 to enable communication with wireless networks using modulated electromagnetic radiation through a non-solid medium. TRx 112 includes a receive signal path, which comprises circuitry to convert analog RF signals (e.g., an existing or received modulated waveform) into digital baseband signals to be provided to the modem 110. The TRx 112 also includes a transmit signal path, which comprises circuitry configurable or operable to convert digital baseband signals provided by the modem 110 to be converted into analog RF signals (e.g., modulated waveform) that will be amplified and transmitted via an antenna array including one or more antenna elements (not shown). The antenna array may be a plurality of microstrip antennas or printed antennas that are fabricated on the surface of one or more printed circuit boards. The antenna array may be formed in as a patch of metal foil (e.g., a patch antenna) in a variety of shapes, and may be coupled with the TRx 112 using metal transmission lines or the like.

The TRx 112 may include one or more radios that are compatible with, and/or may operate according to any one or more of the following radio communication technologies and/or standards or any number of satellite uplink technologies may be used for the TRx 112 including, for example, radios compliant with standards issued by the ITU (International Telecommunication Union), or the ETSI (European Telecommunications Standards Institute), among others, both existing and not yet formulated.

Network interface circuitry/controller (NIC) 116 may be included to provide wired communication to the network 150 or to other devices using a standard network interface protocol. The standard network interface protocol may include Ethernet, Ethernet over GRE Tunnels, Ethernet over Multiprotocol Label Switching (MPLS), Ethernet over USB, or may be based on other types of network protocols, such as Controller Area Network (CAN), Local Interconnect Network (LIN), DeviceNet, ControlNet, Data Highway+, PROFIBUS, or PROFINET, among many others. Network connectivity may be provided to/from the system 100 via NIC 116 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The NIC 116 may include one or more dedicated processors and/or FPGAs to communicate using one or more of the aforementioned network interface protocols. In some implementations, the NIC 116 may include multiple controllers to provide connectivity to other networks using the same or different protocols. For example, the system 100 may include a first NIC 116 providing communications to the cloud over Ethernet and a second NIC 116 providing communications to other devices over another type of network. In some implementations, the NIC 116 may be a high-speed serial interface (HSSI) NIC to connect the system 100 to a routing or switching device.

Network 150 comprises computers, network connections among various computers (e.g., between the system 100 and remote system 155), and software routines to enable communication between the computers over respective network connections. In this regard, the network 150 comprises one or more network elements that may include one or more processors, communications systems (e.g., including network interface controllers, one or more transmitters/receivers connected to one or more antennas, etc.), and computer readable media. Examples of such network elements may include wireless access points (WAPs), a home/business server (with or without radio frequency (RF) communications circuitry), a router, a switch, a hub, a radio beacon, base stations, picocell or small cell base stations, and/or any other like network device. Connection to the network 150 may be via a wired or a wireless connection using the various communication protocols discussed infra. As used herein, a wired or wireless communication protocol may refer to a set of standardized rules or instructions implemented by a communication device/system to communicate with other devices, including instructions for packetizing/depacketizing data, modulating/demodulating signals, implementation of protocols stacks, and the like. More than one network may be involved in a communication session between the illustrated devices. Connection to the network 150 may require that the computers execute software routines which enable, for example, the seven layers of the OSI model of computer networking or equivalent in a wireless (or cellular) phone network.

The network 150 may represent the Internet, one or more cellular networks, a local area network (LAN) or a wide area network (WAN) including proprietary and/or enterprise networks, Transfer Control Protocol (TCP)/Internet Protocol (IP)-based network, or combinations thereof. In such embodiments, the network 150 may be associated with network operator who owns or controls equipment and other elements necessary to provide network-related services, such as one or more base stations or access points, one or more servers for routing digital data or telephone calls (e.g., a core network or backbone network), etc. Other networks can be used instead of or in addition to the Internet, such as an intranet, an extranet, a virtual private network (VPN), an enterprise network, a non-TCP/IP based network, any LAN or WAN or the like.

The external interface 118 (also referred to as “I/O interface circuitry” or the like) is configurable or operable to connect or coupled the system 100 with external devices or subsystems. The external interface 118 may include any suitable interface controllers and connectors to couple the system 100 with the external components/devices. As an example, the external interface 118 may be an external expansion bus (e.g., Universal Serial Bus (USB), FireWire, Thunderbolt, etc.) used to connect system 100 with external (peripheral) components/devices. The external devices include, inter alia, sensor circuitry 121, actuators 122, and positioning circuitry 145, but may also include other devices or subsystems not shown by FIG. 1.

The sensor circuitry 121 may include devices, modules, or subsystems whose purpose is to detect events or changes in its environment and send the information (sensor data) about the detected events to some other a device, module, subsystem, etc. Examples of such sensors 621 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; etc.

The external interface 118 connects the system 100 to actuators 122, which allow system 100 to change its state, position, and/or orientation, or move or control a mechanism or system. The actuators 122 comprise electrical and/or mechanical devices for moving or controlling a mechanism or system, and/or converting energy (e.g., electric current or moving air and/or liquid) into some kind of motion. The actuators 122 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 122 may include one or more electromechanical devices such as pneumatic actuators, hydraulic actuators, electromechanical switches including electromechanical relays (EMRs), motors (e.g., DC motors, stepper motors, servomechanisms, etc.), wheels, thrusters, propellers, claws, clamps, hooks, an audible sound generator, and/or other like electromechanical components. The system 100 may be configurable or operable to operate one or more actuators 122 based on one or more captured events and/or instructions or control signals received from a service provider and/or various client systems. In embodiments, the system 100 may transmit instructions to various actuators 122 (or controllers that control one or more actuators 122) to reconfigure an electrical network as discussed herein.

The positioning circuitry 145 includes circuitry to receive and decode signals transmitted/broadcasted by a positioning network of a global navigation satellite system (GNSS). The positioning circuitry 145 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 145 may include a Micro-Technology for Positioning, Navigation, and Timing (Micro-PNT) IC that uses a master timing clock to perform position tracking/estimation without GNSS assistance. The positioning circuitry 145 may also be part of, or interact with, the communication circuitry 109 to communicate with the nodes and components of the positioning network. The positioning circuitry 145 may also provide position data and/or time data to the application circuitry, which may use the data to synchronize operations with various infrastructure (e.g., radio base stations), for turn-by-turn navigation, or the like.

The input/output (I/O) devices 156 may be present within, or connected to, the system 100. The I/O devices 156 include input device circuitry and output device circuitry including one or more user interfaces designed to enable user interaction with the system 100 and/or peripheral component interfaces designed to enable peripheral component interaction with the system 100. The input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry is used to show or convey information, such as sensor readings, actuator position(s), or other like information. Data and/or graphics may be displayed on one or more user interface components of the output device circuitry. The output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the system 100. The output device circuitry may also include speakers or other audio emitting devices, printer(s), and/or the like. In some embodiments, the sensor circuitry 121 may be used as the input device circuitry (e.g., an image capture device, motion capture device, or the like) and one or more actuators 122 may be used as the output device circuitry (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a universal serial bus (USB) port, an audio jack, a power supply interface, etc.

A battery 124 may be coupled to the system 100 to power the system 100, which may be used in embodiments where the system 100 is not in a fixed location, such as when the system 100 is a mobile or laptop client system. In embodiments where the system 100 is mounted in a fixed location, such as when the system is implemented as a server computer system, the system 100 may have a power supply coupled to an electrical grid.

Power management integrated circuitry (PMIC) 126 may be included in the system 100 to track the state of charge (SoCh) of the battery 124, and to control charging of the system 100. The PMIC 126 may be used to monitor other parameters of the battery 124 to provide failure predictions, such as the state of health (SoH) and the state of function (SoF) of the battery 124.

A power block 128, or other power supply coupled to an electrical grid, may be coupled with the PMIC 126 to charge the battery 124. In some examples, the power block 128 may be replaced with a wireless power receiver to obtain the power wirelessly, for example, through a loop antenna in the system 100.

The system 100 may include any combinations of the components shown by FIG. 1, however, some of the components shown may be omitted, additional components may be present, and different arrangement of the components shown may occur in other implementations. In one example where the system 100 is or is part of a server computer system, the battery 124, communication circuitry 109, the sensors 121, actuators 122, and/or POS 145, and possibly some or all of the I/O devices 156 may be omitted.

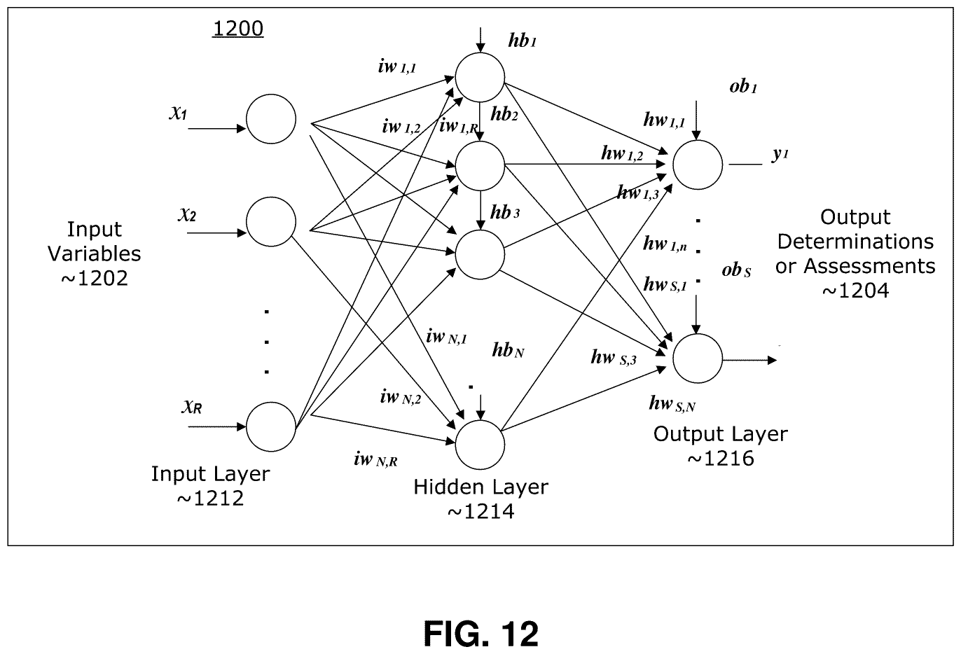

Furthermore, the embodiments of the present disclosure may take the form of a computer program product or data to create the computer program, with the computer program or data embodied in any tangible or non-transitory medium of expression having the computer-usable program code (or data to create the computer program) embodied in the medium. For example, the memory circuitry 104 and/or storage circuitry 108 may be embodied as non-transitory computer-readable storage media (NTCRSM) that may be suitable for use to store instructions (or data that creates the instructions) that cause an apparatus (such as any of the devices/components/systems described with regard to FIGS. 1-35), in response to execution of the instructions by the apparatus, to practice selected aspects of the present disclosure. As shown, NTCRSM may include a number of programming instructions 184, 182 (or data to create the programming instructions). Programming instructions 184, 182 may be configurable or operable to enable a device (e.g., any of the devices/components/systems described), in response to execution of the programming instructions 184, 182, to perform various programming operations associated with operating system functions, one or more applications, and/or aspects of the present disclosure (including various programming). In various embodiments, the programming instructions 184, 182 may correspond to any of the computational logic 180, instructions 182 and 184 discussed previously with regard to FIG. 1.

In alternate embodiments, programming instructions 184, 182 (or data to create the instructions 184, 182) may be disposed on multiple NTCRSM. In alternate embodiments, programming instructions 184, 182 (or data to create the instructions 184, 182) may be disposed on computer-readable transitory storage media, such as, signals. The programming instructions 184, 182 embodied by a machine-readable medium may be transmitted or received over a communications network using a transmission medium via a network interface device (e.g., communication circuitry 109 and/or NIC 116 of FIG. 1) utilizing any one of a number of transfer protocols (e.g., HTTP, etc.).

Any combination of one or more computer usable or computer readable media may be utilized as or instead of the NTCRSM. The computer-usable or computer-readable medium may be, for example but not limited to, one or more electronic, magnetic, optical, electromagnetic, infrared, or semiconductor systems, apparatuses, devices, or propagation media. For instance, the NTCRSM may be embodied by devices described for the storage circuitry 108 and/or memory circuitry 104 described previously. More specific examples (a non-exhaustive list) of a computer-readable medium may include the following: an electrical connection having one or more wires, a portable computer diskette, a hard disk, a random access memory (RAM), a read-only memory (ROM), an erasable programmable read-only memory (EPROM, Flash memory, etc.), an optical fiber, a portable compact disc read-only memory (CD-ROM), an optical storage device and/or optical disks, a transmission media such as those supporting the Internet or an intranet, a magnetic storage device, or any number of other hardware devices. In the context of the present disclosure, a computer-usable or computer-readable medium may be any medium that can contain, store, communicate, propagate, or transport the program (or data to create the program) for use by or in connection with the instruction execution system, apparatus, or device. The computer-usable medium may include a propagated data signal with the computer-usable program code (e.g., including programming instructions 184, 182) or data to create the program code embodied therewith, either in baseband or as part of a carrier wave. The computer usable program code or data to create the program may be transmitted using any appropriate medium, including but not limited to wireless, wireline, optical fiber cable, RF, etc.

In various embodiments, the program code (or data to create the program code) described herein may be stored in one or more of a compressed format, an encrypted format, a fragmented format, a packaged format, etc. Program code (e.g., programming instructions 184, 182) or data to create the program code as described herein may require one or more of installation, modification, adaptation, updating, combining, supplementing, configuring, decryption, decompression, unpacking, distribution, reassignment, etc. in order to make them directly readable and/or executable by a computing device and/or other machine. For example, the program code or data to create the program code may be stored in multiple parts, which are individually compressed, encrypted, and stored on separate computing devices, wherein the parts when decrypted, decompressed, and combined form a set of executable instructions that implement the program code or the data to create the program code, such as those described herein. In another example, the program code or data to create the program code may be stored in a state in which they may be read by a computer, but require addition of a library (e.g., a dynamic link library), a software development kit (SDK), an application programming interface (API), etc. in order to execute the instructions on a particular computing device or other device. In another example, the program code or data to create the program code may need to be configured (e.g., settings stored, data input, network addresses recorded, etc.) before the program code or data to create the program code can be executed/used in whole or in part. In this example, the program code (or data to create the program code) may be unpacked, configured for proper execution, and stored in a first location with the configuration instructions located in a second location distinct from the first location. The configuration instructions can be initiated by an action, trigger, or instruction that is not co-located in storage or execution location with the instructions enabling the disclosed techniques. Accordingly, the disclosed program code or data to create the program code are intended to encompass such machine readable instructions and/or program(s) or data to create such machine readable instruction and/or programs regardless of the particular format or state of the machine readable instructions and/or program(s) when stored or otherwise at rest or in transit.

The computer program code for carrying out operations of the present disclosure, including for example, programming instructions 184, 182, computational logic 180, instructions 182, and/or instructions 184, may be implemented as software code to be executed by one or more processors using any suitable computer language such as, for example, Python, PyTorch, NumPy, ArcPy, Ruby, Ruby on Rails, Scala, Smalltalk, Java™, C++, C #, “C”, Kotlin, Swift, Rust, Go (or “Golang”), ECMAScript, JavaScript, TypeScript, Jscript, ActionScript, Server-Side JavaScript (SSJS), PHP, Pearl, Lua, Torch/Lua with Just-In Time compiler (LuaJIT), Accelerated Mobile Pages Script (AMPscript), VBScript, JavaServer Pages (JSP), Active Server Pages (ASP), Node.js, ASP.NET, JAMscript, Hypertext Markup Language (HTML), extensible HTML (XHTML), Extensible Markup Language (XML), XML User Interface Language (XUL), Scalable Vector Graphics (SVG), RESTful API Modeling Language (RAML), wiki markup or Wikitext, Wireless Markup Language (WML), Java Script Object Notion (JSON), Apache® MessagePack™, Cascading Stylesheets (CSS), extensible stylesheet language (XSL), Mustache template language, Handlebars template language, Guide Template Language (GTL), Apache® Thrift, Abstract Syntax Notation One (ASN.1), Google® Protocol Buffers (protobuf), Bitcoin Script, EVM® bytecode, Solidity™, Vyper (Python derived), Bamboo, Lisp Like Language (LLL), Simplicity provided by Blockstream™, Rholang, Michelson, Counterfactual, Plasma, Plutus, Sophia, Salesforce® Apex®, Salesforce® Lightning®, and/or any other programming language, markup language, script, code, etc. In some implementations, a suitable integrated development environment (IDE) or software development kit (SDK) may be used to develop the program code or software elements discussed herein such as, for example, Android® Studio™ IDE, Apple® iOS® SDK, or development tools including proprietary programming languages and/or development tools. Furthermore, some or all of the software components or functions described herein can utilize a suitable querying language to query and store information in one or more databases or data structures, such as, for example, Structure Query Language (SQL), noSQL, and/or other query languages. The software code can be stored as a computer- or processor-executable instructions or commands on a physical non-transitory computer-readable medium. The computer program code for carrying out operations of the present disclosure may also be written in any combination of the programming languages discussed herein. The program code may execute entirely on the system 100, partly on the system 100 as a stand-alone software package, partly on the system 100 and partly on a remote computer (e.g., remote system 155), or entirely on the remote computer (e.g., remote system 155). In the latter scenario, the remote computer may be connected to the system 100 through any type of network (e.g., network 150).

While only a single computing device 100 is shown, the computing device 100 may include any collection of devices or circuitry that individually or jointly execute a set (or multiple sets) of instructions to perform any one or more of the operations discussed above. Computing device 100 may be part of an integrated control system or system manager, or may be provided as a portable electronic device configurable or operable to interface with a networked system either locally or remotely via wireless transmission.

Some of the operations described previously may be implemented in software and other operations may be implemented in hardware. One or more of the operations, processes, or methods described herein may be performed by an apparatus, device, or system similar to those as described herein and with reference to the illustrated figures.

FIG. 1 illustrates an example NN 100 suitable for use by a computing system (such as those discussed previously), in accordance with various embodiments. NN 100 may be suitable for use by one or more of the subsystems and/or the various embodiments discussed herein, implemented in part by a hardware accelerator of a UVCS module. As shown, example NN 100 may be a multi-layer feedforward NN (FNN) comprising an input layer 112, one or more hidden layers 114 and an output layer 116. Input layer 112 receives data of input variables (xi) 102. Hidden layer(s) 114 processes the inputs, and eventually, output layer 116 outputs the determinations or assessments (yi) 104. In one example implementation the input variables (xi) 102 of the NN are set as a vector containing the relevant variable data, while the output determination or assessment (yi) 104 of the NN 100 are also as a vector. As an example, the multi-layer FNN may be expressed through the following equations:

$${ho}_{i} = f ( {\sum }_{j = 1}^{R} ( {iw}_{i , j} {x}_{j} ) + {hb}_{i} ) , for i = 1 , … , N$$

$${y}_{i} = f ( {\sum }_{k = 1}^{N} ( {hw}_{i , k} {ho}_{k} ) + {ob}_{i} ) , for i = 1 , … , S$$

In these equations, hoi and yi are the hidden layer variables and the final outputs, respectively. f( ) is typically a non-linear function, such as the sigmoid function or rectified linear (ReLu) function that mimics the neurons of the human brain. R is the number of inputs. N is the size of the hidden layer, or the number of neurons. S is the number of the outputs.

The goal of the FNN is to minimize an error function E between the network outputs and the desired targets, by adapting the network variables iw, hw, hb, and ob, via training, as follows:

$$E = {\sum }_{k = 1}^{m} ( {E}_{k} ) , where {E}_{k} = {\sum }_{p = 1}^{S} {( {t}_{kp} - {y}_{kp} )}^{2}$$

In this equation, ykp and tkp are the predicted and the target values of pth output unit for sample k, respectively, and m is the number of samples. In embodiments, the NN 100 is used for one or more computing subsystems, such as those discussed herein. The input variables (xi) 102 may include various data collected by remote devices/sensors, data collected by various embedded or accessible sensors, data obtained via the message exchanges, as well as data describing relevant factors to a decision. The output variables (yi) 104 may include determined response (e.g., adjusting speed, braking, changing lane(s), and so forth). The network variables of the hidden layer(s) for the NN 100, are determined by the training data.

The features used may be implementation specific, and may be based on, for example, the objects to be detected and the model(s) to be developed and/or used. The evaluation phase involves identifying or classifying objects by comparing obtained image data with existing object models created during the enrollment phase. During the evaluation phase, features extracted from the image data are compared to the object identification models using a suitable pattern recognition technique. The object models may be qualitative or functional descriptions, geometric surface information, and/or abstract feature vectors, and may be stored in a suitable database that is organized using some type of indexing scheme to facilitate elimination of unlikely object candidates from consideration.

In one example, the NN 100 is used for the motion detection based on the y sensor data obtained from the one or more sensors. In another example, the NN 100 is used for object detection/classification. The object detection or recognition models may include an enrollment phase and an evaluation phase. During the enrollment phase, one or more features are extracted from the sensor data (e.g., image or video data). A feature is an individual measureable property or characteristic. For object detection, an object feature may include an object size, color, shape, relationship to other objects, and/or any region or portion of an image, such as edges, ridges, corners, blobs, and/or some defined regions of interest (ROI), and/or the like.

In another example, the NN 100 is used for object tracking. The object tracking and/or computer vision techniques may include, for example, edge detection, corner detection, blob detection, a Kalman filter, Gaussian Mixture Model, Particle filter, Mean-shift based kernel tracking, an ML object detection technique (e.g., Viola-Jones object detection framework, scale-invariant feature transform (SIFT), histogram of oriented gradients (HOG), etc.), a deep learning object detection technique (e.g., fully convolutional neural network (FCNN), region proposal convolution neural network (R-CNN), single shot multibox detector, ‘you only look once’ (YOLO) algorithm, etc.), and/or the like.

In another example, the NN 100 is used for character recognition, where the features may include histograms counting the number of black pixels along horizontal and vertical directions, number of internal holes, stroke detection and many others.

In another example, the NN 100 is used for topic classification, where features may include individual topics, tokens, sequences of tokens, term frequency, document frequency and/or inverse document frequency, log-count ratios (e.g., when a Naive Bayes algorithm is used), and/or the like.

In another example, the NN 100 is a feature extraction model that learns to extract salient features from information objects represented using, for example, word embedding. Word embedding is a distributed representation of words where different words that have a similar meaning (e.g., based on their usage) also have a similar representation. Additionally or alternatively, a fully connected model may be used to interpret the extracted features in terms of predictive output. In this example, the NN 100 may be a Convolution NN (CNN), which may be integrated into a larger network, and to be trained to work in tandem with it in order to produce an end result. The CNNs layer's responsibility is to extract meaningful sub-structures that are useful for the overall prediction task at hand. Other aspects of CNNs and the NN 100 being used for topic classification and/or NLP are discussed in Error! Reference source not found.

In the example of FIG. 1, for simplicity of illustration, there is only one hidden layer in the NN, however in some embodiments, there can be multiple hidden layers. Furthermore, the NN can be implemented using other types of topologies, such as Convolution NN (CNN), Recurrent NN (RNN), a Long Short Term Memory (LSTM) algorithm, a deep CNN (DCN), a Deconvolutional NN (DNN), a gated recurrent unit (GRU), a deep belief NN, a feed forward NN (FFN), a deep FNN (DFF), a deep stacking network, a Markov chain, a perception NN, a Bayesian Network (BN), a Dynamic BN (DBN), a Linear Dynamical Systems (LDS), a Switching LDS (SLDS), and/or any other suitable NN arrangement or topology such as those discussed herein.

### Machine Learning Aspects

Machine learning (ML) involves programming computing systems to optimize a performance criterion using example (training) data and/or past experience. ML involves using algorithms to perform specific task(s) without using explicit instructions to perform the specific task(s), but instead relying on learnt patterns and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm” refers to different concepts than the term “ML model,” these terms may be used interchangeably for the purposes of the present disclosure.

ML techniques generally fall into the following main types of learning problem categories: supervised learning, unsupervised learning, and reinforcement learning. Supervised learning is an ML task that aims to learn a mapping function from the input to the output, given a labeled data set. Supervised learning algorithms build models from a set of data that contains both the inputs and the desired outputs. For example, supervised learning may involve learning a function (model) that maps an input to an output based on example input-output pairs or some other form of labeled training data including a set of training examples. Each input-output pair includes an input object (e.g., a vector) and a desired output object or value (referred to as a “supervisory signal”). Supervised learning can be grouped into classification algorithms, regression algorithms, and instance-based algorithms.

Classification, in the context of ML, refers to an ML technique for determining the classes to which various data points belong. Here, the term “class” or “classes” may refer to categories, and are sometimes called “targets” or “labels.” Classification is used when the outputs are restricted to a limited set of quantifiable properties. Classification algorithms may describe an individual (data) instance whose category is to be predicted using a feature vector. As an example, when the instance includes a collection (corpus) of text, each feature in a feature vector may be the frequency that specific words appear in the corpus of text. In ML classification, labels are assigned to instances, and models are trained to correctly predict the pre-assigned labels of from the training examples. ML algorithms for classification may be referred to as a “classifier.” Examples of classifiers include linear classifiers, k-nearest neighbor (kNN), decision trees, random forests, support vector machines (SVMs), Bayesian classifiers, convolutional neural networks (CNNs), among many others (note that some of these algorithms can be used for other ML tasks as well).

A regression algorithm and/or a regression analysis, in the context of ML, refers to a set of statistical processes for estimating the relationships between a dependent variable (often referred to as the “outcome variable”) and one or more independent variables (often referred to as “predictors”, “covariates”, or “features”). Examples of regression algorithms/models include logistic regression, linear regression, gradient descent (GD), stochastic GD (SGD), and the like.

Instance-based learning (sometimes referred to as “memory-based learning”), in the context of ML, refers to a family of learning algorithms that, instead of performing explicit generalization, compares new problem instances with instances seen in training, which have been stored in memory. Examples of instance-based algorithms include k-nearest neighbor, and the like), decision tree Algorithms (e.g., Classification And Regression Tree (CART), Iterative Dichotomiser 3 (ID3), C4.5, chi-square automatic interaction detection (CHAID), etc.), Fuzzy Decision Tree (FDT), and the like), Support Vector Machines (SVM), Bayesian Algorithms (e.g., Bayesian network (BN), a dynamic BN (DBN), Naive Bayes, and the like), and ensemble algorithms (e.g., Extreme Gradient Boosting, voting ensemble, bootstrap aggregating (“bagging”), Random Forest, and the like.

In the context of ML, an “ML feature” (or simply “feature”) is an individual measureable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features. A set of features may be referred to as a “feature vector.” A vector is a tuple of one or more values called scalars, and a feature vector may include a tuple of one or more features. The vector space associated with these vectors is often called a “feature space.” In order to reduce the dimensionality of the feature space, a number of dimensionality reduction techniques can be employed.

Unsupervised learning is an ML task that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Some examples of unsupervised learning are K-means clustering, principal component analysis (PCA), and topic modeling, among many others. In particular, topic modeling is an unsupervised machine learning technique scans a set of information objects (e.g., documents, webpages, etc.), detects word and phrase patterns within the information objects, and automatically clusters word groups and similar expressions that best characterize the set of information objects. Semi-supervised learning algorithms develop ML models from incomplete training data, where a portion of the sample input does not include labels. One example of unsupervised learning is topic modeling. Topic modeling involves counting words and grouping similar word patterns to infer topics within unstructured data. By detecting patterns such as word frequency and distance between words, a topic model clusters feedback that is similar, and words and expressions that appear most often. With this information, the topics of individual set of texts can be quickly deduced.

Reinforcement learning (RL) is a goal-oriented learning based on interaction with environment. In RL, an agent aims to optimize a long-term objective by interacting with the environment based on a trial and error process. Examples of RL algorithms include Markov decision process, Markov chain, Q-learning, multi-armed bandit learning, and deep RL.

An artificial neural network or neural network (NN) encompasses a variety of ML techniques where a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), a deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), etc.), deep stacking network (DSN).

ML may require, among other things, obtaining and cleaning a dataset, performing feature selection, selecting an ML algorithm, dividing the dataset into training data and testing data, training a model (e.g., using the selected ML algorithm), testing the model, optimizing or tuning the model, and determining metrics for the model. Some of these tasks may be optional or omitted depending on the use case and/or the implementation used. ML algorithms accept parameters and/or hyperparameters (collectively referred to herein as “training parameters,” “model parameters,” or simply “parameters” herein) that can be used to control certain properties of the training process and the resulting model.

Parameters are characteristics or properties of the training process that are learnt during training. Model parameters may differ for individual experiments and may depend on the type of data and ML tasks being performed. Hyperparameters are characteristics, properties, or parameters for a training process that cannot be learnt during the training process and are set before training takes place. The particular values selected for the parameters and/or hyperparameters affect the training speed, training resource consumption, and the quality of the learning process. As examples, model parameters for topic classification/modeling, natural language processing (NLP), and/or natural language understanding (NLU) may include word frequency, sentence length, noun or verb distribution per sentence, the number of specific character n-grams per word, lexical diversity, constraints, weights, and the like. Examples of hyperparameters may include model size (e.g., in terms of memory space or bytes), whether (and how much) to shuffle the training data, the number of evaluation instances or epochs (e.g., a number of iterations or passes over the training data), learning rate (e.g., the speed at which the algorithm reaches (converges to) the optimal weights), learning rate decay (or weight decay), the number and size of the hidden layers, weight initialization scheme, dropout and gradient clipping thresholds, and the like. In embodiments, the parameters and/or hyperparameters may additionally or alternatively include vector size and/or word vector size.

Any of the aforementioned ML techniques may be utilized, in whole or in part, and variants and/or combinations thereof, for any of the example embodiments discussed herein.

The terminology used herein is for the purpose of describing particular embodiments only and is not intended to be limiting of the disclosure. The present disclosure has been described with reference to flowchart illustrations and/or block diagrams of methods, apparatus (systems), and/or computer program products according to embodiments of the present disclosure. In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

Although the various example embodiments and example implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

1. A non-transitory computer readable medium (NICRM) having stored thereon software instructions that, when executed by a set of one or more processors, are configurable to cause the set of one or more processors to perform operations comprising:
displaying a user interface (UI) to a customer over a network, and receiving a name or web domain of the customer, and receiving any optional data points, including historical context data;
identifying a set of topics that are most relevant to a product or service of the customer based on the name or web domain of the customer;
ranking the set of topics in order of highest relevancy;
determining which topics in the ranked set of topics most closely match with a set of target topics for which a target company has shown interest, the target topics having a corresponding topic interest score indicating an interest level;
associating the matching topics with the corresponding topic interest scores from the target topics;
identifying at which buying funnel stage the matching topics are in based on the topic interest scores of the matching topics, and the historical context data indicating a pattern of consumed content of the target company; and
generating an intent signal comprising the matching topics, corresponding topic interest scores, and associated buying funnel stage of the matching topics.

2. The NTCRM of claim 1, wherein the operations further comprise:
displaying the ranked set of topics to the customer; and
receiving a selection of topics from the customer to include in the ranked set of topics.

3. The NTCRM of claim 1, wherein the operations further comprise:
receiving segmentation data from the customer; and
filtering the ranked set of topics based on the segmentation data.

4. The NTCRM of claim 3, wherein the segmentation data comprises at least one of: a target account list (TAL), industry information, revenue information, employee count information, and geographic focus information.

5. The NTCRM of claim 1, wherein identifying the set of topics comprises:
performing a graph lookup process to determine whether any company-related terms are found within a topic taxonomy; and
responsive to determining that entity-level topics are returned by the graph lookup process, saving the entity-level topics in a signal definition.

6. The NTCRM of claim 5, wherein the operations further comprise:
responsive to determining that the graph lookup process fails to return any entity-level topics, determining if the optional data points include any keywords;
responsive to determining that the optional data points include keywords, mapping each of the keywords to URLs;
storing the keywords, any PDFs, and the URLs mapped from the keywords in a repository; and
extracting content from the PDFs and URLs and matching the content to relevant topics from a topic taxonomy.

7. The NTCRM of claim 6, wherein matching the content to relevant topics comprises:
classifying the extracted content as business-to-business (B2B) content; and
matching only the B2B content to relevant topics from the topic taxonomy.

8. The NTCRM of claim 6, wherein the operations further comprise:
performing the graph lookup process to determine whether any of the relevant topics are linked to any additional topics in the topic taxonomy; and
responsive to determining that the graph lookup process returns additional topics, adding the relevant topics and the additional topics to the signal definition.

9. The NTCRM of claim 8, wherein the operations further comprise:
responsive to determining that the graph lookup process fails to return any additional topics, performing a graph inference process to identify additional topics that are predicted to be relevant concept-level topics and named entity topics based on graph relationships; and
responsive to determining that the graph inference process returns inferred relevant topics, adding the inferred relevant topics to the signal definition.

10. The NTCRM of claim 9, wherein the operations further comprise:
responsive to determining that the graph inference process fails to return any inferred relevant topics, executing a similarity algorithm to suggest an additional set of similar topics from the topic taxonomy based on topics in the signal definition; and
adding the additional set of similar topics to the signal definition.

11. The NTCRM of claim 1, wherein identifying at which buying funnel stage the matching topics are in comprises:
analyzing the historical context data to determine an acceleration of online research frequency and depth of engagement in the matching topics by the target company during different buying funnel stages; and
associating each of the matching topics with a corresponding buying funnel stage based on the analysis.

12. The NTCRM of claim 11, wherein the historical context data comprises customer relationship management (CRM) data describing closed lost deals or closed won deals.

13. The NTCRM of claim 1, wherein the buying funnel stage comprises at least one of: a top funnel stage, a middle funnel stage, and a bottom funnel stage.

14. The NTCRM of claim 1, wherein the operations further comprise:
aggregating the topic interest scores of the matching topics to generate a single intent signal score; and
associating the single intent signal score with a signal strength grade.

15. A method comprising:
receiving, by a content consumption monitor (CCM), a name or web domain of a customer and historical context data;
identifying, by the CCM, a set of topics that are most relevant to the customer based on the name or web domain;
ranking, by the CCM, the set of topics in order of highest relevancy;
determining, by the CCM, which topics in the ranked set of topics most closely match with a set of target topics for which a target company has shown interest, the target topics having a corresponding topic interest score indicating an interest level;
associating, by the CCM, the matching topics with the corresponding topic interest scores from the target topics;
identifying, by the CCM, at which buying funnel stage the matching topics are in based on the topic interest scores of the matching topics, and the historical context data indicating a pattern of consumed content of the target company; and
generating, by the CCM, an intent signal comprising the matching topics, corresponding topic interest scores, and associated buying funnel stage of the matching topics.

16. The method of claim 15, further comprising:
receiving segmentation data from the customer; and
filtering the ranked set of topics based on the segmentation data.

17. The method of claim 15, wherein identifying the set of topics comprises:
performing a graph lookup process to determine whether any company-related terms are found within a topic taxonomy;
responsive to determining that entity-level topics are returned by the graph lookup process, saving the entity-level topics in a signal definition;
responsive to determining that the graph lookup process fails to return any entity-level topics, extracting content from any provided PDFs and URLs and matching the content to relevant topics from the topic taxonomy; and
performing at least one of a graph inference process and a similarity algorithm to identify additional topics to add to the signal definition.

18. The method of claim 15, wherein identifying at which buying funnel stage
the matching topics are in comprises:
analyzing the historical context data to determine an acceleration of online research frequency and depth of engagement in the matching topics by the target company during different buying funnel stages; and
associating each of the matching topics with a corresponding buying funnel stage based on the analysis.

19. A system comprising:
a processor; and
a memory having instructions stored thereon that, when executed by the processor, cause the processor to:
receive a name or web domain of a customer and historical context data;
identify a set of topics that are most relevant to the customer based on the name or web domain;
rank the set of topics in order of highest relevancy;
determine which topics in the ranked set of topics most closely match with a set of target topics for which a target company has shown interest, the target topics having a corresponding topic interest score indicating an interest level;
associate the matching topics with the corresponding topic interest scores from the target topics;
identify at which buying funnel stage the matching topics are in based on the topic interest scores of the matching topics, and the historical context data indicating a pattern of consumed content of the target company; and
generate an intent signal comprising the matching topics, corresponding topic interest scores, and associated buying funnel stage of the matching topics.

20. The system of claim 19, wherein the instructions further cause the processor to:
receive segmentation data from the customer;
filter the ranked set of topics based on the segmentation data;
aggregate the topic interest scores of the matching topics to generate a single intent signal score; and
associate the single intent signal score with a signal strength grade.
